(19) United States
(12) Patent Application Publication
(10) Pub. No.: US 2013/0204572 A1
(43) Pub. Date: Aug. 8, 2013

(54) STATE DETECTION DEVICE, ELECTRONIC APPARATUS, AND PROGRAM

(71) Applicant: SEIKO EPSON CORPORATION, Tokyo (JP)

(72) Inventor: Shinya SATO, Matsumoto-shi (JP)

(73) Assignee: SEIKO EPSON CORPORATION, Tokyo (JP)

(21) Appl. No.: 13/759,460

(22) Filed: Feb. 5, 2013

(30) Foreign Application Priority Data
Feb. 7, 2012 (JP) 2012-023578
Feb. 7, 2012 (JP) 2012-023824
Feb. 7, 2012 (JP) 2012-023825

(51) Int. Cl. G01P 3/00; G06F 17/00

(52) U.S. Cl. CPC G01P 3/00; G06F 17/00
USPC 702/141

(57) ABSTRACT

A state detection device includes a horizontal direction component extracting unit that obtains a horizontal direction component of acceleration detected by an acceleration sensor and a movement direction calculating unit that calculates a movement direction on the basis of the horizontal direction component. The movement direction calculating unit performs a process of extracting a DC component for movement direction information which is obtained on the basis of the horizontal direction component to calculate the movement direction.

The present application claims a priority based on Japanese Patent Application No. 2012-023578 filed on Feb. 7, 2012, Japanese Patent Application No. 2012-023824 filed on Feb. 7, 2012 and Japanese Patent Application No. 2012-023825 filed on Feb. 7, 2012, the contents of which are incorporated herein by reference.

### BACKGROUND

1. Technical Field

The prevent invention relates to, for example, a state detection device, an electronic apparatus, and a program.

2. Related Art

In recent years, dead reckoning (DR) has been used as a method of estimating the position and trajectory of a walking person, a traveling vehicle, and a flying airplane. This method is different from a method of acquiring absolute position information, such as GPS information, and is a relative position estimating method that estimates a variation (the amount of movement) of the known initial value.

When dead reckoning is performed for a walking person, it is considered that an acceleration sensor is fixed to a predetermined part of the person and a variation is estimated on the basis of the sensor information of the acceleration sensor. However, it is necessary to estimate a movement direction in addition to the distance traveled, in order to perform the dead reckoning.

The walking of the person is considered to be close to a uniform motion in a long span, but is considered as a motion in which acceleration and deceleration are repeated in a short span, such as each step. Therefore, it is possible to estimate the movement direction by checking a change in the acceleration and deceleration. For example, JP-A-2003-302419 discloses a method which detects the peak of the acceleration power of horizontal components (all directions around the person) and estimates the movement direction using a horizontal component acceleration value at the peak. The acceleration of the horizontal component is based on, for example, NED coordinates, which makes it possible to estimate the movement direction based on the north direction.

In the method according to the related art, a method of fixing (holding) a terminal provided with the acceleration sensor is limited. For example, the terminal is held by the hand and the determined axis is aligned with the movement direction. As a result, there is a problem in the convenience of the user.

However, it is considered that, when restrictions in the method of fixing the terminal are relaxed, the position of the terminal is not stable. For example, when the user walks with the terminal in hand (particularly without considering the maintenance of the position), sensor information is affected by, for example, the shaking of the hand and the estimated movement direction is not stable. As a result, a variation at each step increases.

### SUMMARY

An advantage of some aspects of the invention is to provide, for example, a state detection device, an electronic apparatus, and a program which estimate a movement direction with high accuracy on the basis of sensor information of an acceleration sensor while improving flexibility in the fixing position of the acceleration sensor.

An aspect of the invention is directed to a state detection device including: a horizontal direction component extracting unit that obtains a horizontal direction component of acceleration detected by an acceleration sensor; and a movement direction calculating unit that calculates a movement direction on the basis of the horizontal direction component. The movement direction calculating unit performs a process of extracting a DC component for movement direction information which is obtained on the basis of the horizontal direction component to calculate the movement direction.

In the aspect of the invention, the process of extracting the DC component is performed for the movement direction information which is obtained on the basis of the horizontal direction component of the detected acceleration to calculate the movement direction. Therefore, it is possible to prevent a variation in the estimated movement direction due to, for example, rolling and stably estimate the movement direction.

In the aspect of the invention, the state detection device may further include a change information acquiring unit that acquires change information corresponding to a change in the movement direction. The movement direction calculating unit may adjust a parameter which is used in the extraction process on the basis of the change information.

In this way, the DC component extracting process can prevent a change to be detected from being suppressed and it is possible to estimate the movement direction with high accuracy, as compared to a case in which the parameter is not adjusted.

In the aspect of the invention, the movement direction calculating unit may include a DC component extracting and filtering unit that performs a filtering process of extracting the DC component. The movement direction calculating unit may adjust a gain of a filter used in the DC component extracting and filtering unit as the parameter used in the extraction process.

In this way, it is possible to adjust the gain of the filter as the parameter.

In the aspect of the invention, the DC component extracting and filtering unit may perform a process based on the gain for a difference between an input value at a predetermined time point and an output value at a time point that is one time point earlier than the predetermined time point to calculate an intermediate value. The process of extracting the DC component may be performed using a difference between the intermediate value and the input value at the predetermined time point as the output value at the predetermined time point.

In this way, it is possible to specify a detailed filter as the DC component extraction filter.

In the aspect of the invention, the movement direction calculating unit may reduce the value of the gain as the magnitude of the change in the movement direction indicated by the change information increases.

Since the value of the gain is reduced as the amount of change information increases, it is possible to perform the filtering process that allows a change in the movement direction.

In the aspect of the invention, the change information acquiring unit may acquire a change in a rotation angle of an apparatus provided with the acceleration sensor as the change information.

In this way, it is possible to acquire the change information from position information such as the rotation angle of the apparatus.

In the aspect of the invention, the state detection device may further include a step detecting unit that detects first to N-th (N is an integer equal to or greater than 2) steps as steps in walking or running. The change information acquiring unit may average the change information at an i-th (1≦i≦N) step corresponding to one of a right foot and a left foot and the change information at a j-th (1≦j≦N, i≠j) step corresponding to the other step of the right foot and the left foot which is different from the i-th step and output the averaged change information.

In this way, it is possible to prevent a variation in the change information for each step and acquire high-accuracy change information.

In the aspect of the invention, the movement direction calculating unit may average the movement direction information at an m-th (1≦m≦N) step corresponding to one of the right foot and the left foot and the movement direction information at an n-th (1≦n≦N, m≠n) step corresponding to the other step of the right foot and the left foot which is different from the m-th step and perform the process of extracting the DC component for the averaged information to calculate the movement direction.

In this way, it is possible to prevent a variation in the movement direction information for each step and acquire high-accuracy movement direction information.

In the aspect of the invention, the horizontal direction component extracting unit may extract, as the horizontal direction component, a first coordinate axis component and a second coordinate axis component different from the first coordinate axis component. The movement direction calculating unit may perform the process of extracting the DC component for a first movement direction information item which is obtained on the basis of the first coordinate axis component and perform the process of extracting the DC component for a second movement direction information item which is obtained on the basis of the second coordinate axis component. The movement direction calculating unit may calculate the movement direction on the basis of the first movement direction information item subjected to the extraction process and the second movement direction information item subjected to the extraction process.

In this way, even when two components are used as the horizontal direction component, it is possible to perform the DC component extracting process.

In the aspect of the invention, the state detection device may further include a filtering unit that performs a filtering process of removing a DC component for the horizontal direction component of the detected acceleration. The movement direction calculating unit may perform the process of extracting the DC component for the movement direction information which is obtained on the basis of the horizontal component subjected to the filtering process of removing the DC component to calculate the movement direction.

In this way, it is possible to calculate the movement direction information on the basis of the horizontal direction component from which the DC component has been removed.

Another aspect of the invention is directed to an electronic apparatus including the above-mentioned state detection device.

Still another aspect of the invention is directed to a program that causes a computer to function as: a horizontal direction component extracting unit that obtains a horizontal direction component of acceleration detected by an acceleration sensor; and a movement direction calculating unit that calculates a movement direction on the basis of the horizontal direction component. The movement direction calculating unit performs a process of extracting a DC component for movement direction information which is obtained on the basis of the horizontal direction component to calculate the movement direction.

### BRIEF DESCRIPTION OF THE DRAWINGS

The invention will be described with reference to the accompanying drawings, wherein like numbers reference like elements.

FIG. 1 is a diagram illustrating an example of the system structure of a state detection device according to this embodiment.

FIG. 2 is a diagram illustrating an example of a filter used in a filtering unit.

FIG. 3 is a diagram illustrating resultant acceleration information before and after a filtering process.

FIGS. 4A and 4B are diagrams illustrating an example of a horizontal direction component before and after the filtering process.

FIG. 5 is a diagram illustrating a peak detecting process.

FIG. 6 is a flowchart illustrating a step detecting process.

FIG. 7 is a diagram illustrating the relationship between resultant acceleration information and a horizontal direction component.

FIG. 8 is a diagram illustrating the relationship between the horizontal direction component and a movement direction.

FIG. 9 is a diagram illustrating a method of setting an integration period based on the resultant acceleration information.

FIG. 10 is a flowchart illustrating an integration process.

FIG. 11 is a diagram illustrating an averaging process.

FIG. 12 is a flowchart illustrating the averaging process.

FIGS. 13A and 13B are diagrams illustrating a DC component extracting process and a parameter adjusting process.

FIG. 14 is a diagram illustrating an example of a DC component extraction filter.

FIG. 15 is a diagram illustrating a position information (yaw angle) averaging process.

FIG. 16 is a diagram illustrating a position information (yaw angle) averaging process.

FIG. 17 is a flowchart illustrating the DC component extracting process and the parameter adjusting process.

FIG. 18 is a diagram illustrating a method of estimating the movement direction from the horizontal component.

FIG. 19 is a diagram illustrating an example of the structure of an electronic apparatus according to this embodiment.

FIG. 20 is a diagram illustrating an example of the structure of a system including an information storage medium which stores a program according to this embodiment.

### DESCRIPTION OF EXEMPLARY EMBODIMENTS

Hereinafter, an embodiment will be described. The following embodiment does not limit the content of the invention described in the appended claims. In addition, all of the components described in this embodiment are not necessarily indispensable components of the invention.

### 1. Method According to this Embodiment

First, a method according to this embodiment will be described. A method according to the related art has been proposed which estimates the movement direction of the user who is walking using the value of acceleration detected by an acceleration sensor. The movement direction estimated by the proposed method is used for, for example, dead reckoning.

As in the method disclosed in JP-A-2003-302419, in the estimation of the movement direction using the acceleration sensor, it is considered to use the horizontal direction component of acceleration (for example, components which are included in the plane perpendicular to the gravity direction, that is, an N component indicating the north direction and an E component indicating the east direction). However, in the method according to the related art, there are restrictions in the mounting position or position of a terminal provided with the acceleration sensor, in order to acquire the horizontal direction component of acceleration. For example, there is a restriction that one axis of a three-axis acceleration sensor is maintained to be aligned with the gravity direction and the plane indicated by the remaining two axes is maintained to be aligned with the horizontal plane. According to the method of the related art, it is possible to acquire the horizontal direction component only by using the sensor information of the acceleration sensor or only by simply converting the coordinates, horizontal direction component. As a result, the process is simplified. However, the user needs to always consider, for example, the position of the terminal, which causes a convenience problem.

Therefore, the inventors have studied to improve flexibility in, for example, the position of the terminal. Specifically, a coordinate transformation matrix corresponding to the position of the terminal is calculated using, for example, a quaternion and the horizontal direction component is calculated from a value after the coordinate transformation. In this way, the fixing position of the terminal can be freely selected from many positions, such as a breast pocket, a pant pocket, a tote bag, a waist bag, and the waist. At that time, there is no restriction in the position of the terminal. In addition, the terminal may be moderately fixed to the body. Therefore, the terminal may be held by the hand according to the situation. Specifically, when the terminal (for example, a mobile phone) is stabilized, with the user viewing a display unit thereof, the user may hold the terminal with the hand.

However, even when the horizontal direction component can be extracted, there is a problem in the accuracy of estimating the movement direction which is calculated from the horizontal direction component. This is because the value of walking acceleration in the vertical direction (gravity direction) is large, but the value of the horizontal direction component thereof is very small. Therefore, the signal which is desired to be detected is less likely to be distinguished from a noise component, such as a signal generated by the rolling of the user (which is shaking corresponding to a fixing portion of the acceleration sensor and may be the shaking of the entire body or the shaking of the hand when the terminal is held by the hand).

The inventors propose three methods for improving the accuracy of estimating the movement direction. First, information (hereinafter, referred to as movement direction information) for calculating the movement direction is calculated from the integration value of the detected acceleration. For example, in JP-A-2003-302419, the peak value of the horizontal component is the movement direction information. However, it is difficult to detect the peak in a situation in which the influence of noise is great. When an integration process is performed, it is not necessary to strictly detect the peak. Therefore, it is easy to perform the process and it is not necessary to consider a reduction in accuracy due to an error in peak detection. In addition, when the integration process is performed, a DC component, such as an offset, is also integrated, which affects the estimation of the movement direction according to the situation. Therefore, in this embodiment, in a stage before the integration process, a filtering process is performed to remove a DC component from the horizontal direction component (including a reduction in the DC component).

Second, a process of averaging the calculated movement direction information is performed. In this embodiment, the problem is the walking or running of a person. In terms of the human body structure, the rotation direction of the waist is different when a person steps forward with the right foot and when a person steps forward with the left foot. Specifically, when the person steps forward with the right foot, the waist rotates in the counterclockwise direction. When the person steps forward with the left foot, the waist rotates in the clockwise direction. For the movement direction in along span, the movement direction deviates to the left direction when the person steps forward with the right foot and deviates to the right direction when the person steps forward with the left foot. A variation in the movement direction in a short span is not preferable. Therefore, the process of averaging the movement direction information is performed to remove the variation when the person steps forward with the right foot and when the person steps forward with the left foot. The terminal can be fixed to a portion separated from the waist to prevent the variation. However, as described above, in this embodiment, since it is premised to reduce restrictions in the fixation of the terminal, it is necessary to consider the averaging process.

Third, a process of extracting a DC component from the obtained movement direction information is performed. Even though the first and second methods are used, the estimated movement direction is likely to be unstable due to the influence of, for example, rolling. In particular, when the terminal is held by the hand, it is difficult to maintain the relative position of the hand with respect to the body and the relative position is greatly affected by rolling. Therefore, a filtering process of extracting the DC component is performed to prevent the movement direction from being unstable. However, only the extraction of the DC component prevents a change in the movement direction when the user changes the direction, which is not preferable. Therefore, it is necessary to appropriately adjust a parameter (for example, the gain of the filter) corresponding to the degree of suppression of the change.

Next, an example of a system structure will be described and then a step detection method which is the premise of the process will be described. Thereafter, as a process of calculating the movement direction information, the first to third methods will be described. Finally, a movement direction calculating process based on the movement direction information will be described.

### 2. Example of System Structure

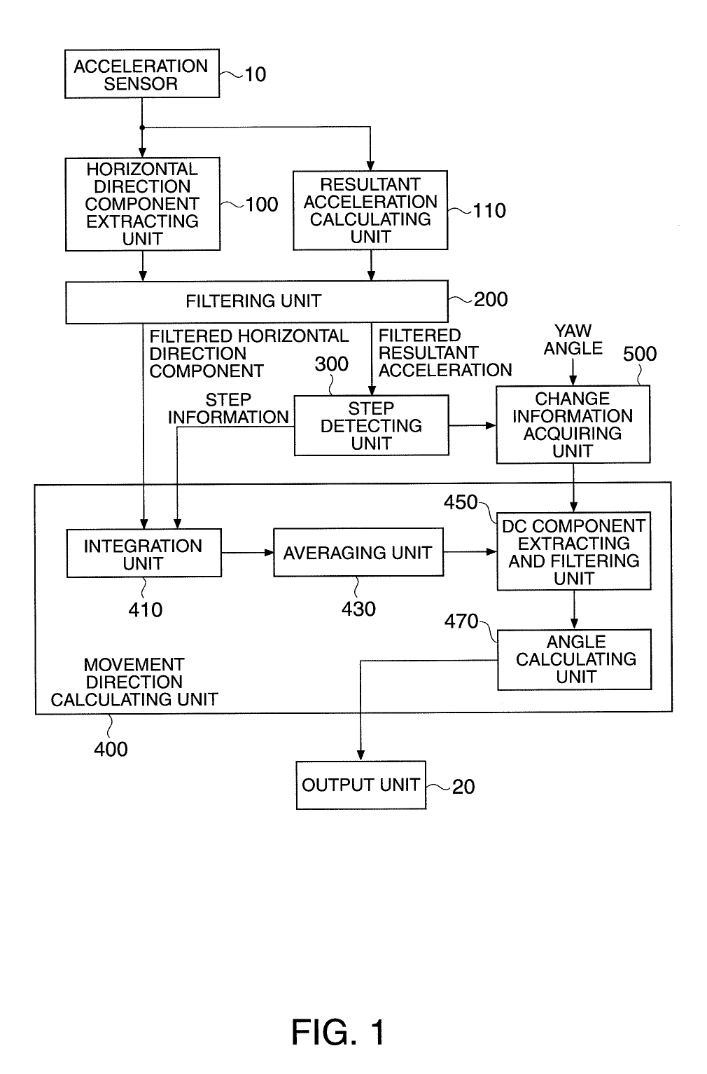

An example of the structure of a state detection device according to this embodiment will be described with reference to FIG. 1. As shown in FIG. 1, the state detection device includes a horizontal direction component extracting unit 100, a resultant acceleration calculating unit 110, a filtering unit 200, a step detecting unit 300, a movement direction calculating unit 400, and a change information acquiring unit 500. In addition, the state detection device may include an acceleration sensor 10 and an output unit 20. However, the state detection device is not limited to the structure shown in FIG. 1, but may have various other structures. For example, some of the components may be omitted or other components may be added.

The acceleration sensor 10 is, for example, a three-axis acceleration sensor. As described above, in this embodiment, since it is premised to improve flexibility in the fixing position or position of the acceleration sensor, the coordinate system of the acceleration sensor is generally different from a coordinate system (for example, a NED coordinate system having the gravity direction, the north direction, and the east direction as axes) used for processing.

The horizontal direction component extracting unit 100 extracts the horizontal direction component from the acceleration detected by the acceleration sensor. Specifically, the horizontal direction component extracting unit 100 may calculate a coordinate transformation matrix for transforming the coordinate system of the acceleration sensor to the coordinate system used for processing and perform transformation on the basis of the coordinate transformation matrix. The coordinate transformation matrix is calculated on the basis of the position of the acceleration sensor (or the terminal provided with the acceleration sensor) relative to a reference position. Information about the position may be obtained from a quaternion and the quaternion may be calculated from the sensor information of the acceleration sensor. Sensor information of other sensors (for example, a geomagnetic sensor or a gyro sensor) may be used to calculate the quaternion. In addition, the sensor information may not be used as such, but, for example, the output of a Kalman filter which is used for a process, such as dead reckoning, may be used. In this case, it is possible to improve the calculation accuracy of the quaternion.

The resultant acceleration calculating unit 110 obtains resultant acceleration information from the acceleration detected by the acceleration sensor. Any method may be used to calculate the resultant acceleration. For example, resultant acceleration Power may be calculated from the detected three-axis acceleration x, y, and z by the following Expression (1).

Power=\sqrt{x²+y²+z²} (1)

The filtering unit 200 performs a filtering process on the horizontal direction component output from the horizontal direction component extracting unit 100 and the resultant acceleration output from the resultant acceleration calculating unit 110. The filtering process removes a DC component and will be described in detail below.

The step detecting unit 300 detects steps on the basis of the filtered resultant acceleration. The step corresponds to one step when the user is walking or running in a narrow sense and will be described in detail below.

The movement direction calculating unit 400 calculates the movement direction. The movement direction calculating unit 400 includes an integration unit 410, an averaging unit 430, a DC component extracting and filtering unit 450, and an angle calculating unit 470. However, the movement direction calculating unit 400 is not limited to the structure shown in FIG. 1, but may have various other structures. For example, some of the components thereof may be omitted or other components may be added.

The integration unit 410 performs an integration process on the filtered horizontal direction component output from the filtering unit 200 and calculates the movement direction information. The start time and end time of the integration process may be determined on the basis of the information (step information) output from the step detecting unit 300. In this case, information is output from the integration unit 410 at the time corresponding to the step (for example, the information is output once per step). However, the start time and end time of the integration process may be determined on the basis of information other than the step information.

The averaging unit 430 performs the averaging process on the movement direction information (for example, the output of the integration unit 410). The DC component extracting and filtering unit 450 performs the filtering process on the movement direction information (for example, the output of the averaging unit 430). Parameters related to a filter which is used in the DC component extracting and filtering unit may be determined on the basis of change information which is output from the change information acquiring unit 500. The filtering process performed by the DC component extracting and filtering unit 450 is a process of extracting a DC component from the movement direction information and is different from the filtering process which is performed by the filtering unit 200 to remove a DC component from the detected acceleration.

The angle calculating unit 470 calculates angle information indicating the movement direction on the basis of the final movement direction information (for example, the output of the DC component extracting and filtering unit 450). The angle information is an angle with respect to the reference direction (for example, the north direction). The process of each component of the movement direction calculating unit 400 will be described in detail below.

The change information acquiring unit 500 acquires the change information indicating a change in the movement direction. The change information may be a change in the position of the terminal in a narrow sense.

The output unit 20 outputs information about, for example, the calculated movement direction. The output unit 20 may be a display unit implemented by, for example, a liquid crystal display or an organic EL display.

### 3. Moving Average and Removal of DC Component

Preprocessing which is performed on the horizontal direction component extracted by the horizontal direction component extracting unit 100 and the resultant acceleration calculated by the resultant acceleration calculating unit 110 will be described. Specifically, a moving average is used to easily remove noise and then a filtering process for removing a DC component is performed.

The moving average may be calculated using, for example, eight samples. In this case, it is possible to expect that the accuracy of estimating the step detection (peak detection) or the movement direction will be improved.

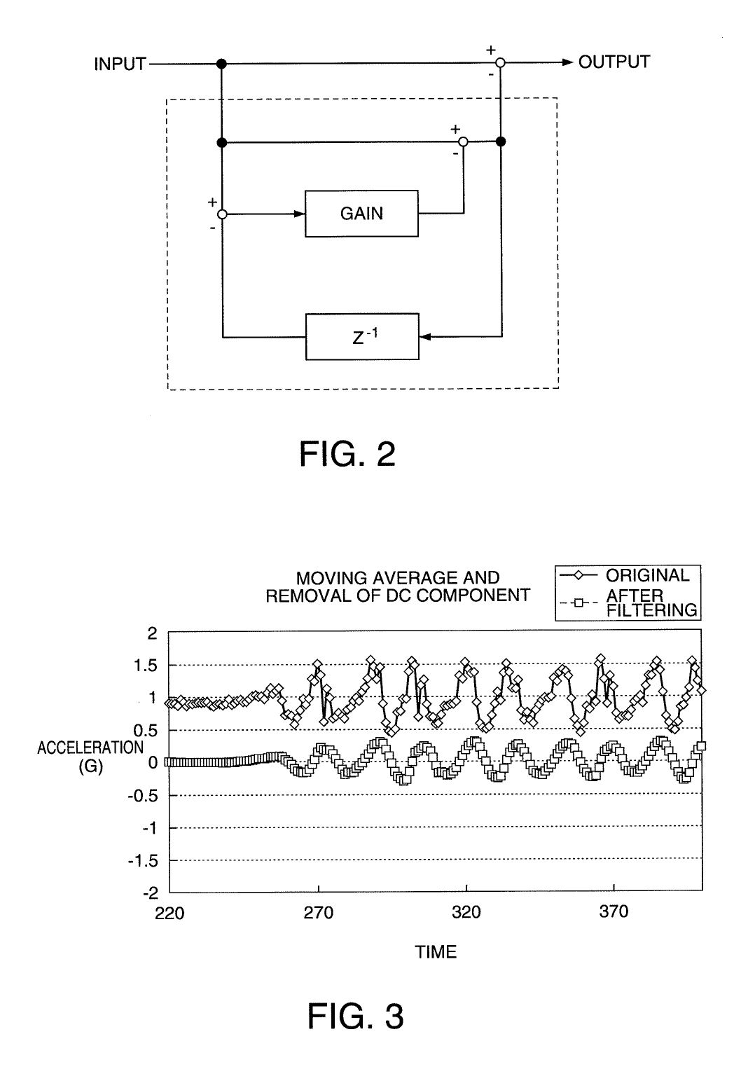

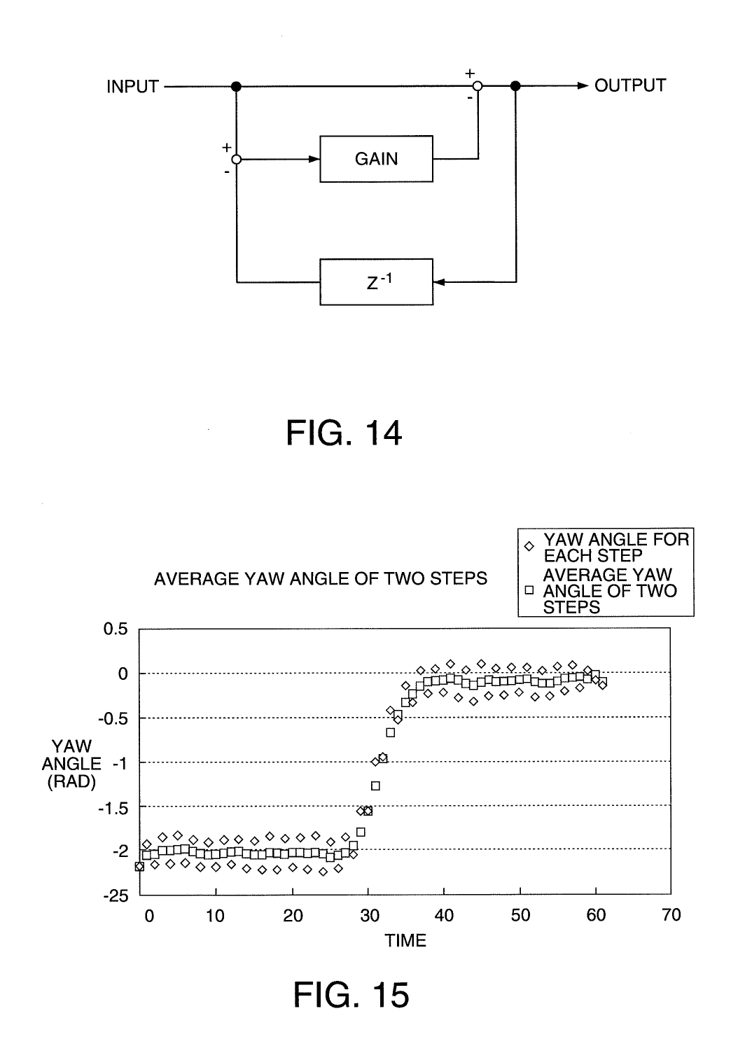

In addition, a process of removing a DC component is performed. Specifically, the filter shown in FIG. 2 may be used. In FIG. 2, a portion surrounded by a dotted line corresponds to a filter for extracting a DC component, which will be described with reference to FIG. 14. In the entire filter shown in FIG. 2, the difference between an input value and the output (that is, a DC component) of the portion surrounded by the dotted line is calculated. As a result, it is possible to remove a DC component.

The DC components are removed from both the horizontal direction component and the resultant acceleration. The DC component is removed from the horizontal direction component in order to prevent the integration of an offset (bias) in the subsequent integration process. The DC component is removed from the resultant acceleration in order to improve the accuracy of step detection.

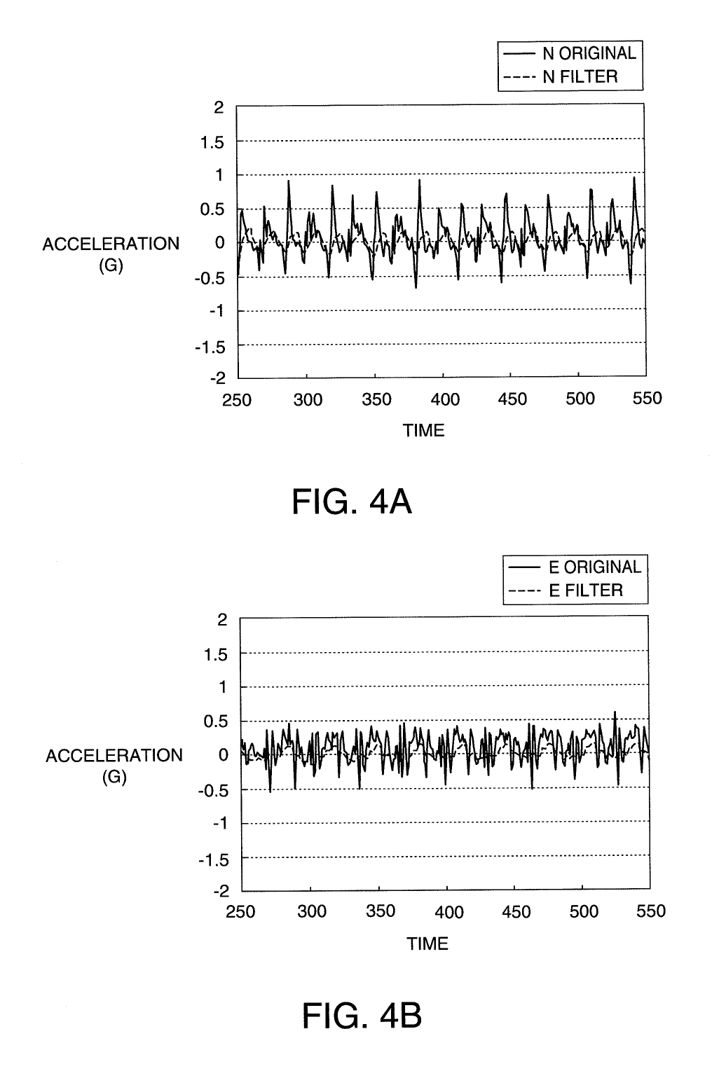

The gain shown in FIG. 2 may be a fixed value, or a value of, for example, 0.9 may be set to the gain. FIG. 3 shows signals before and after the moving average and the DC component removing process. FIG. 3 shows a change in the resultant acceleration, in which the DC component is cut and has a smooth waveform, as compared to that before the process. FIGS. 4A and 4B show a change in the horizontal direction components (an N component and an E component). As can be seen from FIGS. 4A and 4B, the signal has a smooth waveform, similarly to the resultant acceleration.

In each of the following processes, basically, the signal which has been subjected to the moving average and the DC component removing process is used. However, these processes are not necessarily performed, according to the situation.

### 4. Step Detection

Next, the step detecting process of the step detecting unit 300 will be described. In this embodiment, the peak (an upper peak and a lower peak) of a signal value is detected as the step. It is assumed that the resultant acceleration with a relatively large signal value, not the horizontal direction component with a small signal value, is used in order to improve the accuracy of peak detection.

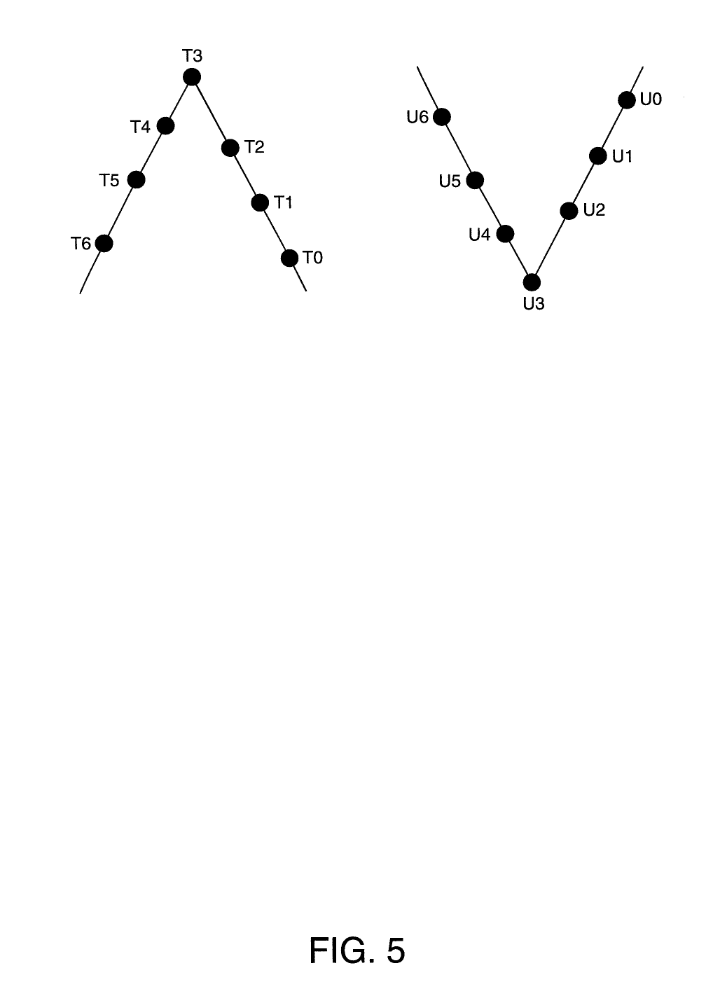

Any method may be used to detect the peak value. For example, the method shown in FIG. 5 may be used. It is assumed that a value is input to the step detecting unit 300 at the time corresponding to the sensor information acquisition rate (for example, 16 Hz) of the acceleration sensor. In FIG. 5, for example, T0, T1 and the like correspond to respective input values. An input value, which is a determination target, is compared with three sample values before and after the determination target to detect the peak. For the detection of the upper peak, when the determination target is greater than three sample values before and after the determination target and the value of the determination target is greater than a predetermined threshold value (for example, 0.4), the determination target sample is recognized as the upper peak. On the contrary, for the detection of the lower peak, when the determination target is less than three sample values before and after the determination target and the value of the determination target is less than a predetermined threshold value (for example, 0.4), the determination target sample may be recognized as the lower peak.

For example, when the lower peak is detected again after the detection of the lower peak, without the upper peak being detected (that is, the lower peaks are successive), any exceptional process is likely to be needed (for example, a motion different from a typical walking motion is made or the sensor information is not normally detected). Therefore, as the detection conditions of the lower peak, the condition that the corresponding upper peak has been detected may be considered in addition to the above. In this case, the detected lower peak makes it possible to secure the normal motion of the user or the normal acquisition of the sensor information. Therefore, it is possible to remove exceptional processing in the subsequent process or simplify the exceptional processing.

The step detecting unit 300 outputs information about the upper peak which is detected by the above-mentioned process as the step information. The step information may be, for example, a pulse signal which is output in correspondence to the detection time of the upper peak and the detection time of the lower peak, or data including a time stamp corresponding to the peak detection time. In addition, the step information may include, for example, the value of the resultant acceleration at the peak detection time according to processing.

The step corresponds to each step in the walking or running of the user. When the step is detected, only one of the upper peak and the lower peak may be output. For example, the change information acquiring unit 500 may use only one of the upper peak and the lower peak for processing. Therefore, it is possible to simplify the step information according to an output destination and the step information can be implemented in various manners.

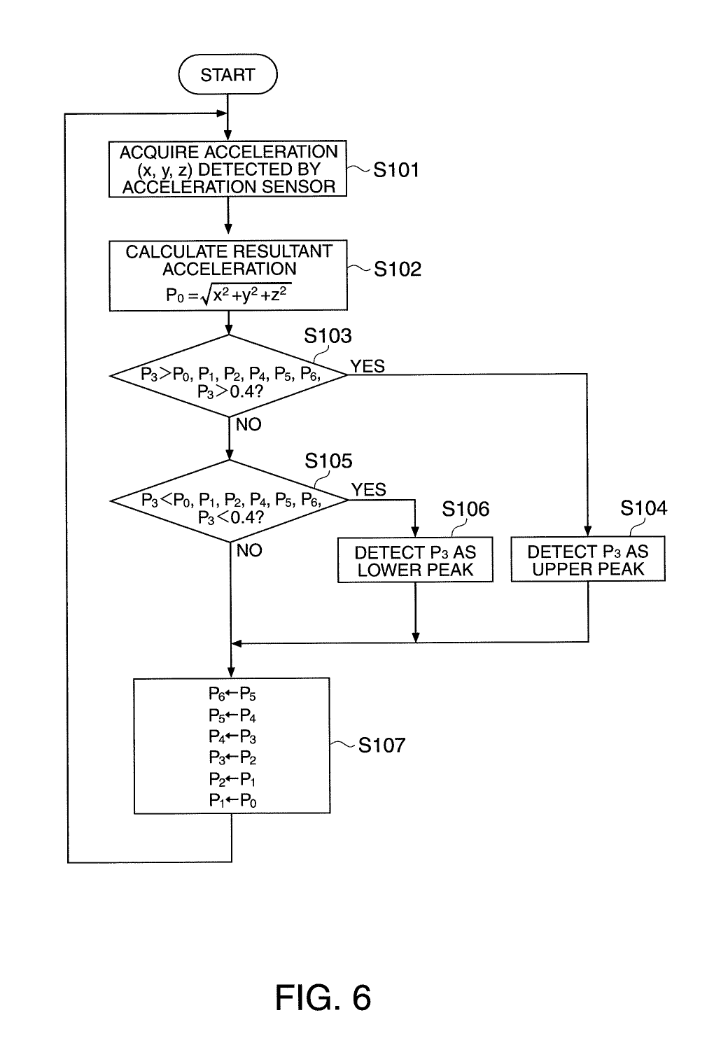

The step detecting process will be described in detail with reference to the flowchart shown in FIG. 6. When the process starts, first, the acceleration detected by the acceleration sensor is acquired (S101). In the case of three-axis acceleration, the values (x, y, and z) of each axis are acquired. Then, the resultant acceleration is calculated on the basis of the detected acceleration. Any combining method may be used. However, in this embodiment, the square root of the sum of squares of the values of each axis is used as the latest resultant acceleration P₀. The above-mentioned processing is performed by the resultant acceleration calculating unit 110 and the processing result is output to the step detecting unit 300. Although not shown in the flowchart of FIG. 6, the filtering unit 200 may perform the filtering process for the calculated resultant acceleration.

Then, the peak is detected using the value of the acquired latest resultant acceleration and the value of the resultant acceleration at the previous time. Specifically, when the resultant acceleration before n time points is Pₙ, the values of P₀ to P₆ are used to compare P₃ with other values and compare P₃ with a predetermined threshold value. When P₃ is considered as a reference value, the comparison is the same as that between P₃ and the values of three samples before and after P₃.

It is determined whether the value of P₃ is greater than each of the values of P₀ to P₂ and each of the values of P₄ to P₆ and is greater than a predetermined threshold value (in this embodiment, 0.4) (S103). When the conditions are satisfied, P₃ is detected as the upper peak (S104). When the determination result in S103 is “No”, it is determined whether the value of P₃ is less than each of the values of P₀ to P₂ and each of the values of P₄ to P₆ and is less than a predetermined threshold value (in this embodiment, 0.4) (S105). When the conditions are satisfied, P₃ is detected as the lower peak (S106). When the determination result in S105 is “No”, it is assumed that neither the upper peak nor the lower peak is detected.

Then, in S107, a process at the next time point is prepared. In addition, information about the previous resultant acceleration required for the comparison process may be stored (in this embodiment, information about the previous six samples is stored). The process in S107 is not limited to a process of updating the variable Pₙ, as shown in FIG. 6.

### 5. Calculation of Movement Direction Information

Next, a process of calculating the movement direction information will be described. In this embodiment, the movement direction information is used to calculate the movement direction. Therefore, the movement direction information may be the sensor information of the acceleration sensor as long as it can calculate the movement direction. However, when an improvement in the accuracy of calculating the movement direction is considered, it is preferable that the desired sensor information be selected or the sensor information be processed. For example, information obtained by the integration process, which will be described below, is the movement direction information. In addition, the averaging process and the DC component extracting process, which will be described below, correspond to a correction process (processing treatment) for the movement direction information and it is assumed that information after these processes is also included in the movement direction information.

### 5.1 Integration Process

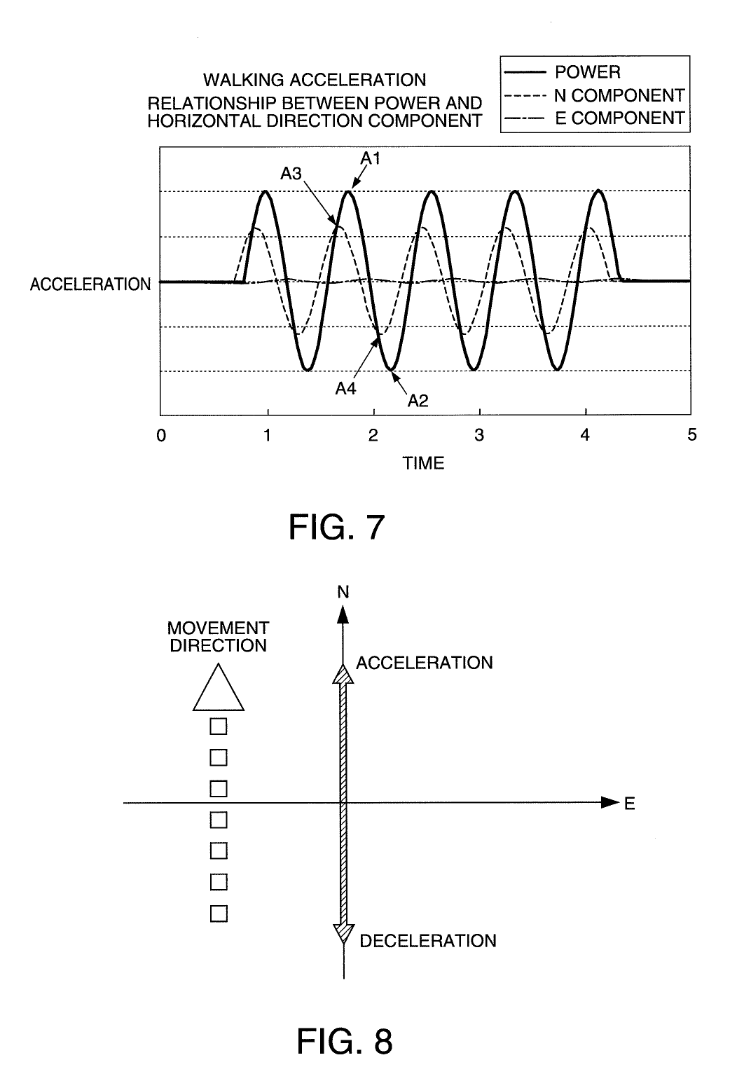

A method of calculating the movement direction information using the integration process will be described. FIG. 7 shows the relationship between the resultant acceleration and the horizontal direction component of the acceleration during walking. FIG. 7 shows the ideal relationship between the resultant acceleration Power and the horizontal direction component decomposed in the NED coordinate system when the user walks north. Since the movement direction is the north, most of the horizontal direction components are N components and there is substantially no E component.

In FIG. 7, A1 corresponds to a case in which the foot of the user is at the highest position and A2 corresponds to a case in which the foot is on the ground. In the step detection, A1 is the upper peak and A2 is the lower peak. A3, which is the maximum acceleration in the movement direction among the horizontal direction components (here, N components), appears immediately before A1 and A4, which is the maximum deceleration (negative maximum acceleration), appears immediately before A2.

As disclosed in, for example, JP-A-2003-302419, when the maximum acceleration of the horizontal direction components corresponding to A3 and A4 is detected, it is possible to estimate the movement direction. When the terms according to this embodiment are used, the peak value of the horizontal direction component is the movement direction information. For example, according to this method, as can be seen from the example shown in FIG. 7, the maximum acceleration and the maximum deceleration are as shown in FIG. 8 and the movement direction is the north. When the movement direction is not the true north or the true south, acceleration and deceleration corresponding to the movement direction appear in the E component. However, the N component and the E component can be combined by any method to calculate the movement direction.

However, since the signal value of the horizontal direction component is very small, it is difficult to detect the peak such as A3 or A4. It is considered to use the peak detection time (A1 and A2) of the resultant acceleration. However, as shown in FIG. 7, A1 and A3 are not likely to be aligned with each other and A2 and A4 are not likely to be aligned with each other. Since the horizontal direction component has a small signal value and is likely to be affected by noise, it is preferable to use the peak values (A3 and A4) with a large signal value. Therefore, when there is a time difference between A1 and A3, the use of the peak detection time of the resultant acceleration causes a serious problem.

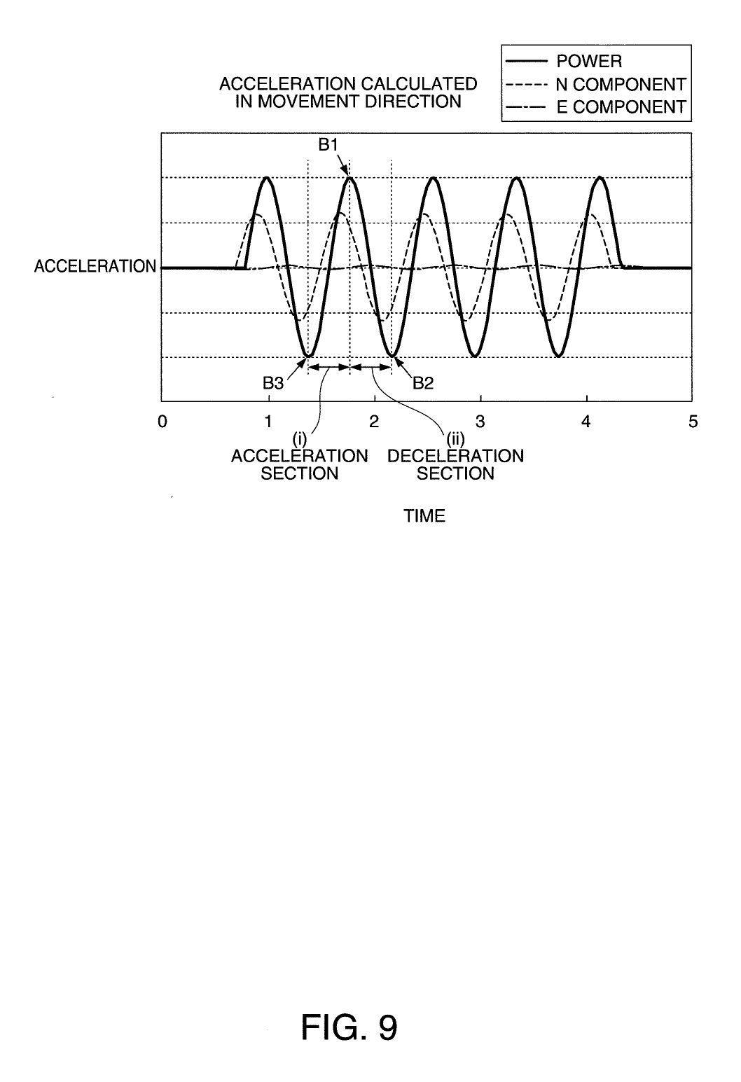

Therefore, in this embodiment, for the period which is determined on the basis of the peaks (A1 and A2) of the resultant acceleration, the horizontal direction component is integrated to calculate the movement direction information. The detailed example thereof is shown in FIG. 9. In FIG. 9, B1 and B2 correspond to A1 and A2 shown in FIG. 8 and indicate the upper peak and the lower peak of the resultant acceleration, respectively. B3 corresponds to the lower peak before one cycle of B2. At that time, when the period from B3 to B1, acceleration (positive value) is dominant in the horizontal direction component for the period due to a difference in the peak detection time between the resultant acceleration and the horizontal direction component. On the contrary, deceleration (negative value) is dominant in the horizontal direction component for the period from B1 to B2. Therefore, when an acceleration section is from B3 to B1 and a deceleration section is from B1 to B2, the integration value of the horizontal direction components in the acceleration section is a positive value (absolute value) that is large enough to calculate the movement direction and the integration value of the horizontal direction components in the deceleration section has a negative value that is large enough to calculate the movement direction.

In this embodiment, at least one of the integration value in the acceleration section and the integration value in the deceleration section is the movement direction information. In the following description, as a detailed example, the integration value in the deceleration section is used. However, the integration value in the acceleration section may be used, or both the integration value in the acceleration section and the integration value in the deceleration section may be used (for example, in the form of the sum or average of the absolute values).

When the horizontal direction components are the N component and the E component, the integration value An_sum of the N component and the integration value Ae_sum of the E component are the movement direction information. The integration process is performed on the value of the horizontal direction component which is input for a target period. The integration method may be simple addition or weighted addition. In addition, other integration methods may be used.

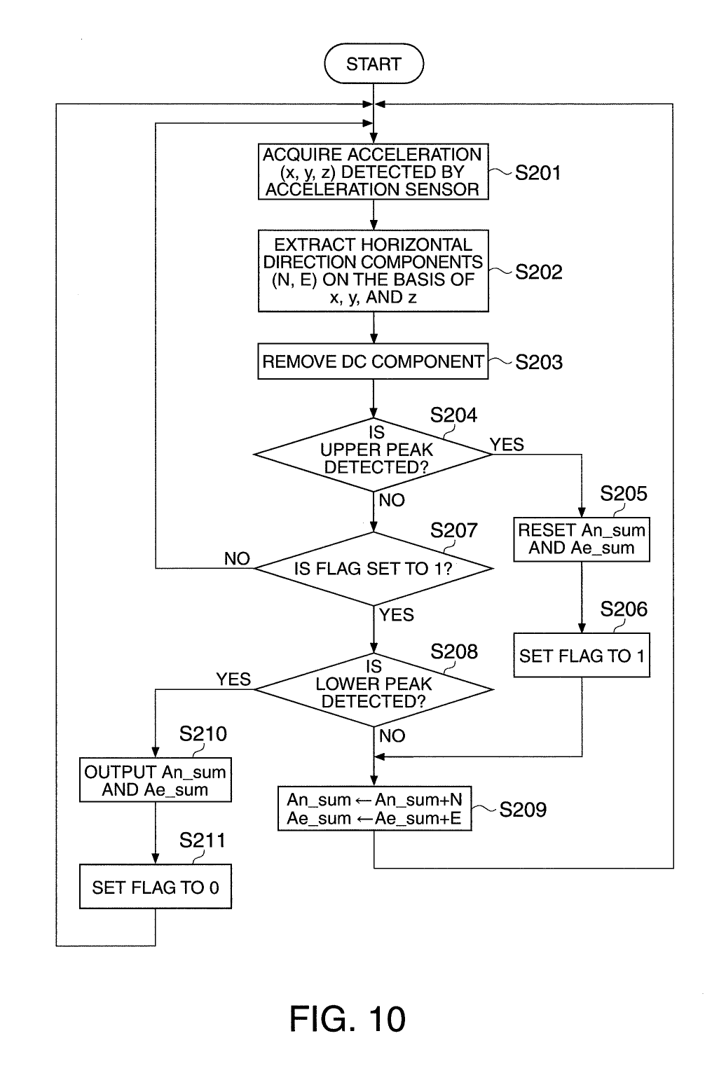

The details of the integration process will be described with reference to the flowchart shown in FIG. 10 using an example in which the integration value in the deceleration section is used. When this process starts, first, the acceleration detected by the acceleration sensor is acquired (S201). In the case of three-axis acceleration, the values (x, y, and z) of each axis are acquired. Then, the horizontal direction component is extracted on the basis of the detected acceleration (S202). Here, the N component and the E component of the NED coordinate system are extracted. The above-mentioned process is performed by the horizontal direction component extracting unit 100. Then, the filtering unit 200 performs a filtering process of removing a DC component for the extracted horizontal direction component (S203). As described above, when the integration process is performed, components which are not preferable to be used for a process, such as offset, are likely to be integrated, which results in a reduction in accuracy. Therefore, these components are removed (or reduced) to prevent the influence of the components.

Then, it is determined whether the upper peak is detected at a processing target time (S204). The actual determination process is performed by the step detecting unit 300 according to the flowchart shown in FIG. 6. The integration unit 410 may acquire the step information from the step detecting unit 300. When the upper peak is detected, the deceleration section starts and a new integration process starts. Specifically, the integration values An_sum and Ae_sum are initialized (S205) and a flag indicating that the upper peak has been detected is set to 1 (S206). Then, the value of the N component from which the DC component is removed in S203 is added to the integration value An_sum and the value of the E component is added to the integration value Ae_sum (S209). After S209, the process returns to S201 and a process based on the next detected acceleration is performed.

When the determination result in S204 is No, the flag is determined (S207). When the flag is 0 (No in S207), no upper peak has not been detected. Therefore, it is determined that the processing target time is not included in the deceleration period and the process returns to S201 without performing, for example, the integration process. When the flag is 1 (Yes in S207), the upper peak has been detected. Therefore, it is determined that the processing target time is included in the deceleration period and the lower peak is determined.

Then, it is determined whether the lower peak is detected at the processing target time (S208). When the lower peak is not detected, it is considered that the time is in the middle of the deceleration section. Therefore, in S209, the value of the N component is added to the integration value An_sum and the value of the E component is added to the integration value Ae_sum. Then, the process returns to S201.

When the lower peak is detected in S208, it is considered that the processing target time is the time of B2 in FIG. 9 and the integration process ends. At that time, the integration values An_sum and Ae_sum are output as the movement direction information (S210). In addition, the flag indicating that the upper peak has been detected is set to 0 and the detection of the upper peak at the next step is prepared (S211). Then, the process returns to S201.

### 5.2 Averaging Process

Next, the process of averaging the movement direction information will be described. As described above, even when the person walks in a predetermined direction in a long span, deviation occurs in the movement direction in a short span such as one step. The reason is that the walking of the person is divided into a step with the right foot and a step with the left foot and the stepping motion with the foot involves the rotation of the waist whose direction varies depending on the foot which the person steps forward with.

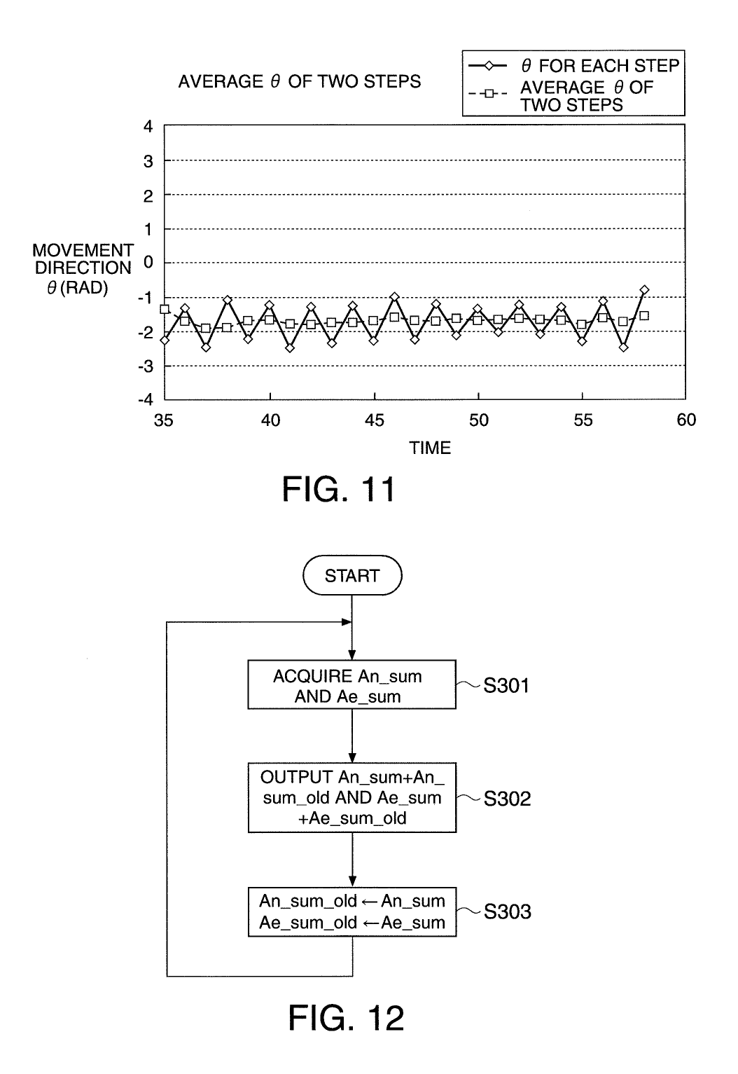

Therefore, for example, when the terminal provided with the acceleration sensor is fixed to the waist, the sensor detects the rotation of the waist. As a result, for example, as represented by θ at each step in FIG. 11, the estimated movement direction greatly varies depending on the foot which the person steps forward with. Therefore, it is considered that, even though the user walks straight, the trajectory drawn by dead reckoning has, for example, a triangular shape, which is not preferable.

Therefore, in this embodiment, the average value of two steps is calculated and is used as the movement direction information. For example, the movement direction information about the step to be processed and the movement direction information about the previous step may be averaged. In this case, as represented by the average θ of two steps in FIG. 11, it is possible to stabilize the estimated movement direction. However, the averaging method is not limited thereto, but the movement direction information about the previous n steps, not the previous one step, may be used to calculate the average value. At that time, a weighted average, not a simple average, may be used. However, in the averaging process according to this embodiment, since the problem is the difference between the right foot and the left foot, the process of averaging the movement direction information items when the person steps forward with the right foot is not effective. That is, it is necessary to use at least one of the movement direction information when the person steps forward with the right foot and the movement direction information when the person steps forward with the left foot.

Next, the details of the averaging process will be described with reference to the flowchart shown in FIG. 12. In the process, for example, it is premised that the movement direction information items An_sum and Ae_sum are calculated by, for example, the integration process. Therefore, the process shown in FIG. 12 is performed once at the time corresponding to the calculation rate of the movement direction information. In a narrow sense, the process is performed once per step.

When this process starts, first, the movement direction information items An_sum and Ae_sum are acquired (S301). Then, the averaging process is performed using movement direction information items An_sum_old and Ae_sum_old (values before the averaging process) which are acquired at the previous step and the averaged movement direction information is output (S302). In S302, the movement direction information items are not divided by 2, but are simply added. However, the ratio of the N component and the E component may be maintained in the estimation of the movement direction. Therefore, the above method does not particularly cause problems. Information obtained by the dividing the information items by 2 may be used as the averaged movement direction information.

Then, in S303, a process in the next step is prepared. According to this example, the movement direction information about the previous step is sufficient to perform the calculation. However, data for the previous n steps may be stored according to the content of the averaging process.

### 5.3 DC Component Extracting Process

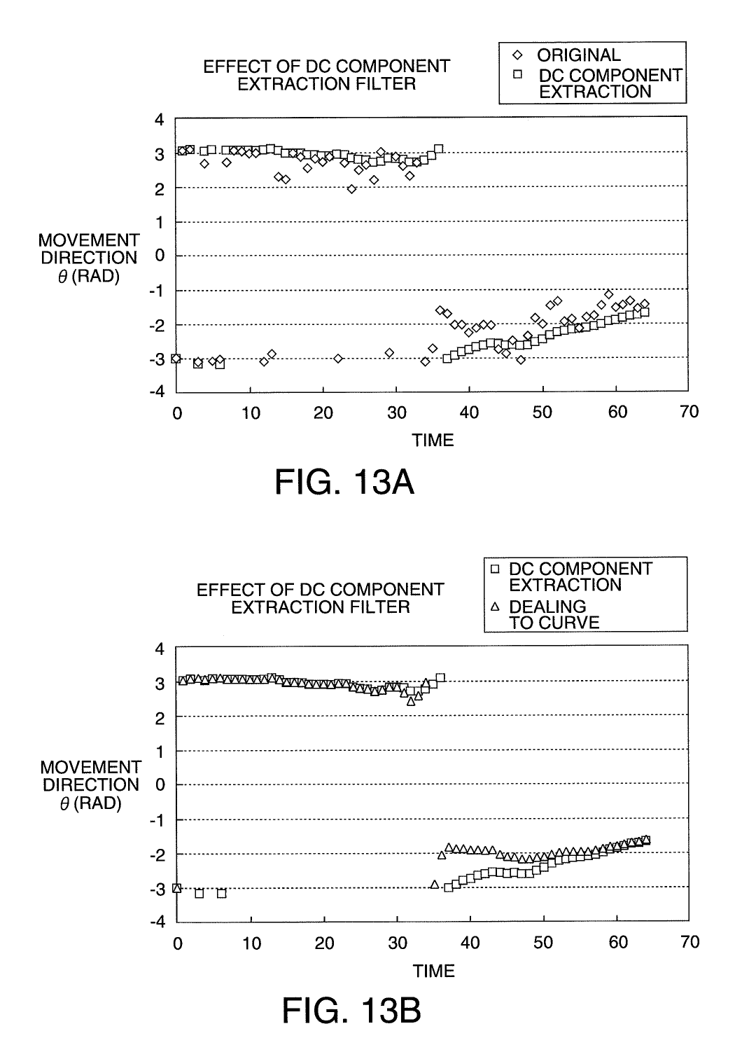

Next, the DC component extracting process will be described. In this embodiment, flexibility in the fixing position or posture of the terminal is improved. Therefore, there is a case in which the terminal is fixed to the waist or the breast pocket, the position of the terminal is relatively stable, and the detection of acceleration in a direction other than the movement direction in the horizontal direction is prevented. On the other hand, there is a case in which the terminal is held by the hand and the position of the terminal is unstable. For example, when the terminal is held by the hand, the estimated movement direction is not stable due to, for example, the shaking of the hand. A detailed example is shown as “original” in FIG. 13A. In FIGS. 13A and 13B, the vertical axis is an angle (radian). In this embodiment, the angle range is from −π to π. Therefore, +π and −π indicate the same direction. Even when the value largely varies from the vicinity of +3 to the vicinity of −3, the estimated movement direction is not always changed greatly in practice, and is not related to the instability of the movement direction, which is the problem of this embodiment.

FIGS. 13A and 13B show a change in the estimated movement direction when the user walks in the direction represented by θ=3 (rad) from a time point 0 and changes its course to the direction represented by θ=−2 (rad) in the vicinity of a time point 35. Even though the actual motion is stable, the estimated movement direction is unstable due to the influence of, for example, rolling, as represented by “original” in FIG. 13A.

Therefore, in this embodiment, a DC component extraction filter for preventing a variation is used in order to stabilize the estimated movement direction. Specifically, the DC component extracting and filtering unit 450 performs the filtering process. FIG. 14 shows a filter which is used in the filtering process. The filter shown in FIG. 14 delays the output value by one time point (that is, the filter uses the output value before one time point) to obtain the difference between the output value and the input value and applies the gain to the difference value. Then, the filter uses the difference between the value to which the gain is applied and the input value as an output value. Since the gain is applied to the difference between the output before one time and the current input, it corresponds to a variation in the value. When the gain is 1, the value of the variation is subtracted from the input value and the variation is removed from the output value. That is, the gain of the filter indicates the degree of suppression of the variation. As the gain is close to 1, the degree of suppression of the variation increases. As the gain is reduced, the degree of suppression of the variation is reduced.

The output value when the gain is fixed to 0.9 in order to stabilize the estimated movement direction is represented by “DC component extraction” in FIG. 13A. In the DC component extraction, instability is removed, as compared to “original”, but a new problem occurs. This motion is a high-speed change in direction in the vicinity of the time point 35 and the value when the DC component is extracted is slowly changed in the vicinity of time points 35 to 60. This is caused by the suppression of a change to be reflected in the output value, such as a change in the movement direction in the motion of the user or a change in the position of the terminal. In this case, even when the direction is changed at the corner of the road at an angle close to 90 degrees, the road is recognized to be gently curved. Therefore, the trajectory drawn by dead reckoning does not reflect the motional state, which is not preferable.

In this embodiment, the gain of the filter used in the DC component extracting and filtering unit 450 is adaptively adjusted. Specifically, when a change in the movement direction is large, the gain is reduced to shift the movement direction to a direction in which the change in the direction is allowed. On the contrary, when the change in the movement direction is small, the gain is increased to suppress the change.

The degree of the change in the movement direction may be calculated on the basis of the previous output value (for example, the difference between the output value before one step and the output value before two steps may be used). However, in this case, the actual processing time is not identical to the time when the movement direction is changed. It is considered that, since the output value is the filtered value in this embodiment, it is difficult to accurately calculate the degree of the change from the previous output value.

In this embodiment, the degree of the change in the movement direction is calculated on the basis of a change in the position of the terminal. It is considered that, when a change in the position of the terminal relative to the body of the user is not large, a (absolute) change in the position of the terminal corresponds to a change in the movement direction. For the position of the terminal, in the process of extracting the horizontal direction component of the detected acceleration, the position used to calculate the coordinate transformation matrix may be used without any change. For example, the position of the terminal is calculated from, for example, a quaternion.

As a change (for example, ΔYaw) in position information (for example, a yaw angle) increases, the value of the gain decreases. For example, when ΔYaw>20° is established, the gain may be 0.4. When ΔYaw>10° is established, the gain may be 0.7. In the other cases, the gain may be 0.9. For the first and second steps which are not capable of calculating ΔYaw, a separate gain may be set. For example, the gain is set to 0 at the first step since there is no stored data for the filter. At the second step, the gain is set to 0.7 since the reliability of data for the first step tends to be reduced. A value when the gain adjusting process is added dealing to a curve in FIG. 13B. As can be seen from FIG. 13B, it is possible to respond to a rapid change in direction in the vicinity of the time 35.

In the averaging process, it has been described that the movement direction (or movement direction information) is different when the person steps forward with the right foot and when the person steps forward with the left foot, which holds for the position information as shown in FIG. 15. That is, even when the person walks in a predetermined direction, the value of yaw angle is different when the person steps forward with the right foot and when the person steps forward with the left foot, which makes it difficult to accurately calculate ΔYaw. Therefore, the averaging process may also be performed on the position information and the gain may be determined on the basis of a change in the averaged position information.

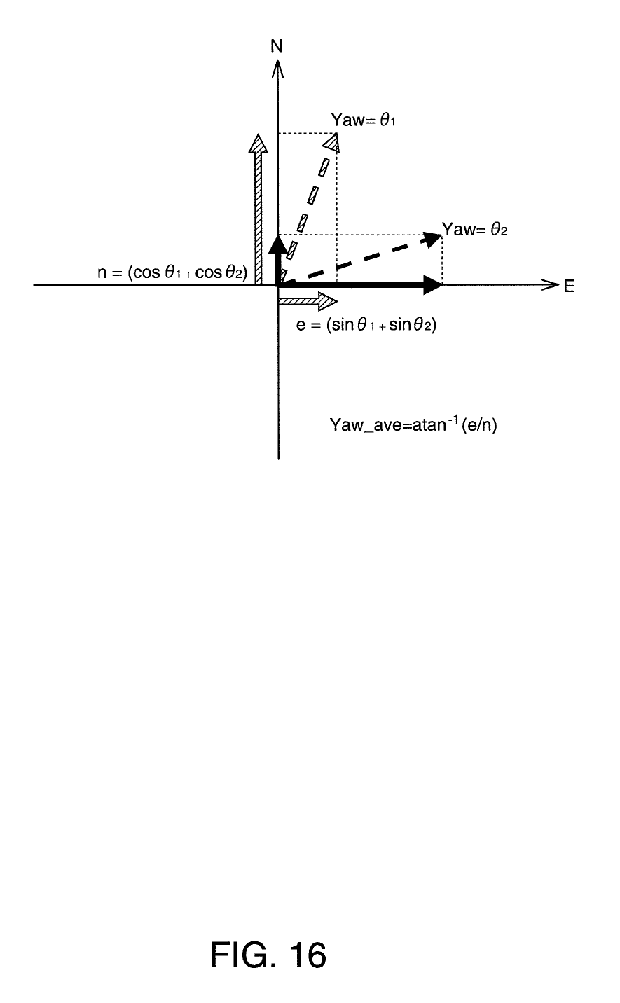

When the previous yaw angle is Yaw_old, a yaw angle after the averaging process may be Yaw_ave=(Yaw+Yaw_old)/2. However, as described above, in this embodiment, information about the angle has a periodic boundary condition in which +π and −π indicate the same direction. When the calculation result is disposed in the vicinity of the boundary, an unexpected result is likely to be obtained. Therefore, the process of averaging the yaw angle is performed by the method shown in FIG. 16. Specifically, a vector indicating Yaw is decomposed into the N direction and the E direction and a vector indicating Yaw_old is also decomposed into the N direction and the E direction. Then, a resultant vector n in the N direction and a resultant vector e in the E direction are calculated and the angle represented by the resultant vectors n and e (specifically, atan of e/n) is Yaw_ave.

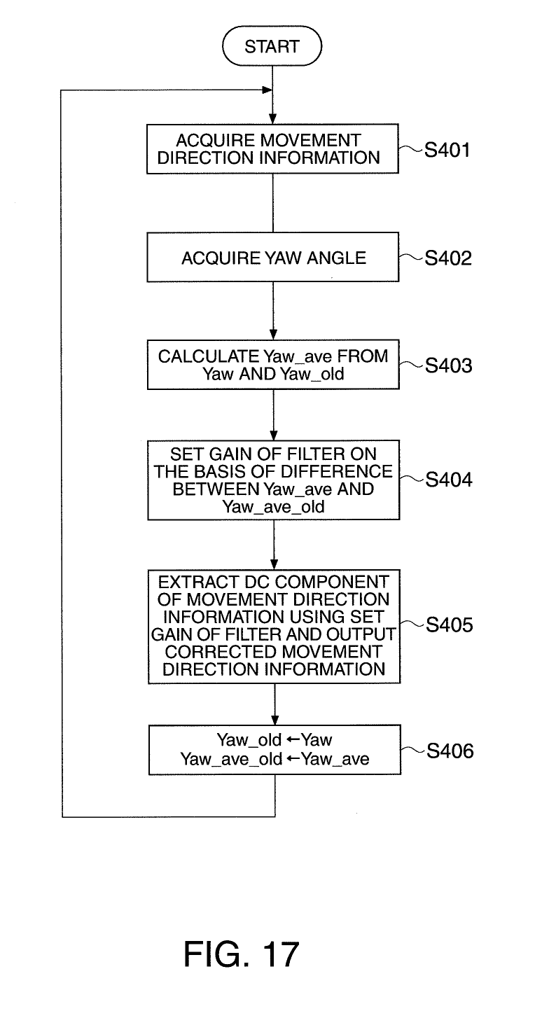

Next, the details of the DC component extracting process (and the gain adjusting process) will be described with reference to the flowchart shown in FIG. 17. When this process starts, first, the DC component extracting and filtering unit 450 acquires the movement direction information (S401). For example, movement direction information items An_sum+An_sum_old and Ae_sum+Ae_sum_old after the averaging process are acquired. Then, the change information acquiring unit 500 acquires the value of the yaw angle as the position information (S402). Then, the process of averaging the yaw angle is performed to calculate an averaged yaw angle Yaw_ave (S403).

Then, a difference value ΔYaw between the averaged yaw angle Yaw_ave and the previous averaged yaw angle (an angle before one step in a narrow sense) Yaw_ave_old and the gain of the filter is set on the basis of ΔYaw (S404). The DC component extracting process is performed using the set gain and the processing result is output (S405). Then, a process in the next step is prepared (S406). Specifically, the value of the yaw angle and the value of the averaged yaw angle corresponding to a necessary number of steps are stored.

### 6. Movement Direction Calculating Process

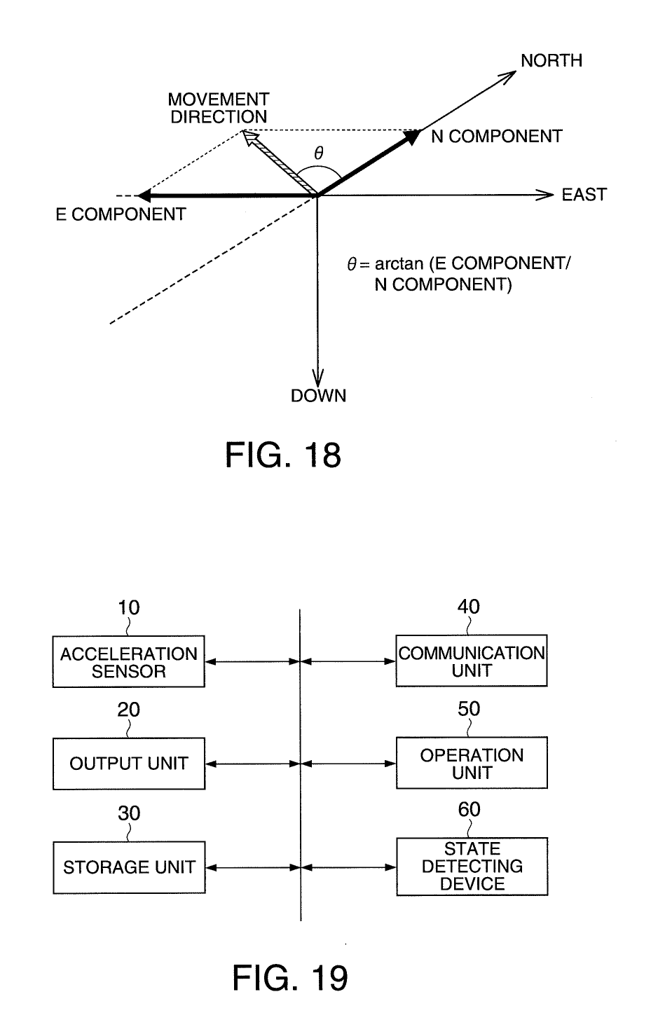

Finally, a process of calculating the movement direction on the basis of the movement direction information will be described. In the method according to this embodiment, the movement direction information is acquires as the values of the N component and the E component. Therefore, as shown in FIG. 18, the movement direction is represented by a resultant vector of the vector of the N component and the vector of the E component. In FIG. 1, the angle calculating unit 470 performs this process.

### 7. Detailed Examples of Embodiment

Each process performed by the state detection device has been described in detail above, but all of the above-mentioned processes are not necessarily performed. For example, the state detection device may include some of the units shown in FIG. 1. Next, detailed examples will be described as the first to third embodiments.

### 7.1 First Embodiment

As shown in FIG. 1, a state detection device may include a horizontal direction component extracting unit 100 that calculates a horizontal direction component from acceleration detected by an acceleration sensor 10, a filtering unit 200 that performs a filtering process of removing a DC component from the horizontal direction component, and a movement direction calculating unit 400 that performs a process of integrating the filtered horizontal direction component to calculate a movement direction. It is assumed that the integration process is performed by an integration unit 410 included in the movement direction calculating unit 400.

In this embodiment, the horizontal direction component is a component in the horizontal direction when the gravity direction is a reference direction. In a narrow sense, when a plane perpendicular to the gravity direction is the horizontal plane, a component of the detected acceleration in the horizontal plane is the horizontal direction component. However, the horizontal direction component is not necessarily a component in the plane perpendicular to the gravity direction, but may be a component in the plane that intersects the gravity direction at an angle different from 90°. In addition, the DC component (direct current component) indicates the center value of the amplitude of a signal waveform. For example, in the case of the waveform “original” (a waveform indicating a variation in the signal value of resultant acceleration over time) shown in FIG. 3, the DC component has a value of about +1 (G).

The removal of the DC component is not limited to a process of completely removing the DC component, but includes a process of reducing the value of the DC component.

In this way, it is possible to calculate the movement direction on the basis of the integration value of the horizontal direction components of the detected acceleration. When the person is walking or running, the signal value of the acceleration sensor mainly appears in the gravity direction and the signal value of the horizontal direction component is small. Therefore, the horizontal direction component is likely to be affected by noise. As disclosed in JP-A-2003-302419, even when the movement direction is calculated from the peak value of the horizontal direction component, it is difficult to determine the time corresponding to the peak. In the method according to this embodiment, since the process of integrating a plurality of horizontal components is performed, it is not necessary to detect the peak value of the horizontal direction component and it is possible to calculate the movement direction information with ease. In addition, for example, the influence of an error related to the peak detection on the estimated movement direction may not be considered.

As shown in FIG. 1, the state detection device may include a step detecting unit 300 that detects steps during walking or running. The movement direction calculating unit 400 performs a process of integrating the filtered horizontal direction components to calculate the movement direction for the period which is set on the basis of the detection result of the step detecting unit 300.

The step corresponds to a unit motion of the object to which the acceleration sensor 10 will be fixed. When the walking or running of the person is considered, the step corresponds to one step of the walking or running. For example, when a vehicle is a target, a unit operation of a driving mechanism of the vehicle may be considered as the step. For example, the step corresponds to one revolution of a turbine in a turbine engine. The step of walking or running corresponds to one step and the start and end times of the step are not limited. For example, one step may be from the time when the person takes a step on the ground to immediately before the person takes the next step on the ground or it may be from the time when the foot reaches the highest position to immediately before the foot reaches the next highest position. In addition, other times may be used as the start and end times.

In this way, it is possible to detect the step and set the period for which the integration process is performed on the basis of the step. When the step is used as a unit of motion as described above, it is assumed that the signal waveform of the detected acceleration has periodicity in the unit of one step. Therefore, since a change in the signal waveform sufficient appears in one step, the integration period is determined on the basis of the step (one step in a narrow sense) to obtain sufficient movement direction information to calculate the movement direction. Since the movement direction information is obtained once per step, it is possible to set the estimation rate of the movement direction to a large value and it is possible to expect that the accuracy of, for example, a dead reckoning process will be improved. However, the integration period may be set over a plurality of steps.

As shown in FIG. 1, the state detection device may include a resultant acceleration calculating unit 110 that calculates resultant acceleration information on the basis of the acceleration detected by the acceleration sensor 10. The step detecting unit 300 detects steps on the basis of the resultant acceleration information calculated by the resultant acceleration calculating unit 110. In addition, the resultant acceleration information may be obtained on the basis of the sum of squares of the detected acceleration.

It is assumed that the acceleration sensor 10 has a plurality of axes and it is considered that the acceleration sensor 10 is a three-axis acceleration sensor in a narrow sense since the movement direction needs to be calculated in the actual space at an arbitrary fixing position. That is, the acceleration sensor 10 outputs values corresponding to the number of axes at a predetermined sensor information output time. In this embodiment, the resultant acceleration is a value which is calculated on the basis of the plurality of values and is, for example, the square root of the sum of squares of the plurality of values. However, a method of calculating the resultant acceleration is not particularly limited and other methods may be used. When a given value (for example, x) is a positive value, another value is (for example, y) a negative value, and, for example, x+y or x³+y³ is used, the sum (absolute value) of the positive value and the negative value is reduced. In the detection of the step, it is preferable that the signal value be large. Therefore, when the sum of squares is used, the values of each axis are not cancelled. For example, an even power may be used.

In this way, it is possible to detect steps on the basis of the resultant acceleration information. In this embodiment, the peak value of the horizontal direction component may not be used in order to integrate the detected acceleration. However, the integration period needs to be appropriately set in order to secure the validity of the integrated information. As described above, for example, step detection is needed in order to secure the validity. Finally, it is necessary to analyze a change in the signal waveform. However, in this case, the detection of one step is needed, but the detection of the peak of the horizontal direction component is not needed. Therefore, the resultant acceleration information is used to detect the step. Since it is assumed that the resultant acceleration information can obtain a large signal value as compared to the horizontal direction component, the detection of the step on the basis of the resultant acceleration information can be performed easier than the detection of the peak detection of the horizontal direction component.

The filtering unit 200 may perform a filtering process of removing a DC component from the resultant acceleration information obtained by the resultant acceleration calculating unit 110. The step detecting unit 300 detects steps on the basis of the filtered resultant acceleration information.

In this way, it is possible to remove a DC component from the resultant acceleration information and detect steps from the filtered resultant acceleration information. It is necessary to detect, for example, a characteristic point (for example, a peak or a zero point) in order to detect the steps. As represented by “original” in FIG. 3, there is a large variation in the calculated resultant acceleration due to, for example, noise, which makes it difficult to accurately detect the steps. However, since the DC component is removed, a filtered smooth waveform shown in FIG. 3 is obtained, which makes it easy to perform the step detecting process.

The step detecting unit 300 may calculate the peak of the resultant acceleration information to detect the steps.

In this case, since the peak is calculated, it is possible to detect the steps. As shown in FIG. 5, the peak may be the upper peak, the lower peak, or both the upper and lower peaks. As described with reference to FIG. 5, the peak can be calculated by a simple process, such as a process of comparing the value of a target sample and the value of a sample before or after the target sample or a process of comparing the value of the target sample with a predetermined threshold value. Therefore, it is possible to reduce a processing load, as compared to, for example, a process of calculating the cycle (frequency) of a signal using frequency analysis, such as FFT, and calculating a step on the basis of the cycle.

The step detecting unit 300 may detect a first peak and a second peak having an acceleration direction different from that of the first peak as the peaks of the resultant acceleration information. The movement direction calculating unit 400 may perform a process of integrating the filtered horizontal direction components to calculate the movement direction for the period from the detection time of the first peak to the detection time of the second peak.

When the resultant acceleration information is a vector (with both a magnitude and a direction), the acceleration direction means a direction indicated by the vector. It is considered that the acceleration directions are different from each other, for example, when the angle formed between two vectors is greater than a predetermined threshold value. However, typically, since the resultant acceleration information is a scalar, such as the sum of squares, the acceleration direction indicates that a value is greater or less than an average value (DC component). In other words, since the filtering process of removing a DC component from the resultant acceleration information is performed, it is considered that the average value is close to 0. Therefore, is assumed that the acceleration directions include a positive direction and a negative direction.

In this way, it is possible to detect two peaks with different acceleration directions and perform the integration process for the period from the detection time of one of the peaks to the detection time of the other peak. Even when the start time of a step is detected and the integration process is performed for the entire period of one step, the horizontal direction components are cancelled since there are the period of a positive value and the period of a negative value as shown in FIG. 4A. Since the horizontal direction component originally has a signal value be small and is likely to be affected by noise, it is preferable that the absolute value of the integration value be large. Therefore, it is necessary to perform the integration period for a portion of the period of one step, not the entire period of one step. However, when the upper peak and the lower peak are used, it is easy to detect the peaks. In addition, since one of a positive value and a negative value is dominant for the period from one peak to the other peak, it is possible to effectively perform the integration process. The acceleration period from the lower peak to the upper peak (a positive value is dominant) may be used or the deceleration period (a negative value is dominant) from the upper peak to the lower peak may be used. In some cases, in predetermined user data, the period (corresponding to the acceleration period) for which the foot rises and the period (corresponding to the deceleration period) for which the foot falls are compared, the period for which the foot falls tends to be short. When a situation is considered in which one of the acceleration period and the deceleration period is likely to be longer than the other period due to the difference between the users or the motional state of the individual users, it is preferable to use the shorter of the acceleration period and the deceleration period, considering the prevention of the accumulation of noise by the integration process.

The movement direction calculating unit 400 may perform, as the process of integrating the horizontal direction component, a process of integrating a first coordinate component and a process of integrating a second coordinate component different from the first coordinate component to calculate the movement direction.

In this way, it is possible to perform the integration process for each of two components included in the horizontal direction and calculate the movement direction on the basis of the result of the integration process. In this embodiment, since flexibility in the fixing position of the acceleration sensor is improved, one axis of the sensor is not necessarily aligned with the movement direction. Therefore, as the horizontal direction component, two predetermined components (for example, an N component in the north direction and an E component in the east direction) are used to calculate the movement direction, as shown in FIG. 18.

The horizontal direction component extracting unit 100 may calculate the horizontal direction component of the detected acceleration on the basis of the position information of an apparatus provided with the acceleration sensor.

In this way, it is possible to extract the horizontal direction component on the basis of the position information. The extracting process may be, for example, a transformation process using a coordinate transformation matrix. The position information is, for example, a quaternion and can be calculated from the sensor information of the acceleration sensor. In addition, a geomagnetic sensor, not the acceleration sensor, may be used to acquire an absolute azimuth direction, or, for example, a gyro sensor may be added. Furthermore, the position information may be obtained with reference to the previous sensor. For example, the output of a Kalman filter may be used. When a process of measuring the number of steps is performed separately from the calculation of the movement direction, it is considered that the Kalman filter is used in the process. Therefore, it is possible to use the Kalman filter to calculate the position information.

### 7.2 Second Embodiment

As shown in FIG. 1, the state detection device may include a movement direction calculating unit 400 that calculates a walking or running direction on the basis of acceleration detected by an acceleration sensor 10 and a step detecting unit 300 that detects steps during walking or running. The movement direction calculating unit 400 (an averaging unit 430 of the movement direction calculating unit 400 in a narrow sense) performs a process of averaging movement direction information corresponding to a first step and movement direction information corresponding to a second step different from the first step to calculate the movement direction at the first step.

In this embodiment, the movement direction information is information which is integrated by the integration unit 410 in a narrow sense, but is not limited thereto. For example, as in the method according to the related art, the peak value of a horizontal direction component may be the movement direction information. In addition, information subjected to an averaging process according to this embodiment may be included in the movement direction information.

In this way, the movement direction information of a predetermined step and the movement direction information of another step can be averaged to calculate the movement direction. When the person walks or runs, the motion of the body is different when the person steps forward with the right foot and when the person steps forward with the left foot. For example, when the acceleration sensor is fixed to the waist, a portion of the waist corresponding to the foot which the person steps with is ahead of another portion opposite to the portion. Therefore, under a predetermined condition, for example, when the acceleration sensor is fixed to the waist, the movement direction estimated for each step varies. The averaging process according to this embodiment makes it possible to prevent the variation and estimate an appropriate movement direction estimate, as shown in FIG. 11.

The first step may correspond to one of the right foot and the left foot and the second step may correspond to the other step of the right foot and the left foot which is different from the first step.

In this way, it is possible to average movement direction information when the person steps forward with the right foot and movement direction information when the person steps forward with the left foot. As described above, since the averaging process according to this embodiment is used to reduce a variation caused by a difference in motion due to the left and right feet, it is not effective to average the movement direction information items obtained from the same motional state. Therefore, an averaging process based on the right foot and the left foot is needed. The averaging process is performed for a target step and the previous step, but the invention is not limited thereto. For example, the averaging process is performed for the target step and a step that is three steps ahead. Three or more movement direction information items may be averaged. For example, the averaging process is performed for a target step and the previous three steps. When it is not necessary to estimate the movement direction in real time during a motion (for example, when sensor information is stored and a process for the sensor information is performed later), the steps to be subjected to the averaging process are not limited to the target step and the previous steps. For example, the averaging process may be used using the movement direction information of a step at a predetermined time point and the movement direction information of another step at a time point later than the predetermined time point of the step.

In addition, as shown in FIG. 1, the state detection device may include a horizontal direction component extracting unit 100 that extracts the horizontal direction component of the acceleration detected by the acceleration sensor 10. The movement direction calculating unit 400 calculates the movement direction information on the basis of the horizontal direction component.

In this way, it is possible to extract the horizontal direction component from the acceleration detected by the acceleration sensor 10. Therefore, it is possible to determine a fixing position without considering the axis of the acceleration sensor 10 and the horizontal direction. In addition, as shown in FIG. 18, it is possible to calculate the movement direction information on the basis of the horizontal direction component.

The horizontal direction component extracting unit 100 may extract, as the horizontal direction component, a first coordinate axis component and a second coordinate axis component different from the first coordinate axis component. The movement direction calculating unit 400 averages the movement direction information obtained from the first coordinate axis component of the first step and the movement direction information of the first coordinate axis component of the second step and obtains the averaged first coordinate axis component. In addition, the movement direction calculating unit 400 averages the movement direction information obtained from the second coordinate axis component of the first step and the movement direction information obtained from the second coordinate axis component of the second step and obtains the averaged second coordinate axis component. Then, the movement direction calculating unit 400 calculates the movement direction on the basis of the averaged first coordinate axis component and the averaged second coordinate axis component.

In this way, even when two components are used as the horizontal direction component, it is possible to perform the averaging process. When the horizontal direction component includes an N component and an E component, two values (for example, An_sum and Ae_sum) are obtained as the movement direction information at the first step and two values (for example, An_sum_old and Ae_sum_old) are obtained as the movement direction information at the second step. In this case, the averaging process may be performed for each axis. For example, An_sum+An_sum_old and Ae_sum+Ae_sum_old are calculated.

As shown in FIG. 1, the state detection device may include a filtering unit 200 that performs a filtering process of removing a DC component from the horizontal direction component of the detected acceleration. The movement direction calculating unit 400 (in a narrow sense, an integration unit 410 of the movement direction calculating unit 400) integrates the filtered horizontal direction component to calculate the movement direction information corresponding to the first step and the movement direction information corresponding to the second step.

In this way, it is possible to use the integrated value as the movement direction information. The advantages of the integration process have been described above.

As shown in FIG. 1, the state detection device may include a resultant acceleration calculating unit 110 that calculates resultant acceleration information on the basis of the sum of squares of the detected acceleration. The filtering unit 200 performs a filtering process of removing a DC component from the resultant acceleration information. The step detecting unit 300 detects steps on the basis of the filtered resultant acceleration information.

In this way, it is possible to calculate the resultant acceleration information from the detected acceleration and perform the filtering process on the resultant acceleration information to detect steps. In this embodiment, each step is detected during walking or running in order to remove a variation due to the difference between the right foot and the left foot. That is, it is necessary to appropriately detect steps and the calculation of the resultant acceleration information and the filtering process are performed in order to detect steps. The reason why the steps are appropriately detected by these processes has been described above.

### 7.3 Third Embodiment

As shown in FIG. 1, a state detection device may include a horizontal direction component extracting unit 100 that extracts the horizontal direction component of the acceleration detected by an acceleration sensor 10 and a movement direction calculating unit 400 that calculates a movement direction on the basis of the horizontal direction component. The movement direction calculating unit 400 (a DC component extracting and filtering unit 450 of the movement direction calculating unit 400 in a narrow sense) performs a process of extracting a DC component from movement direction information obtained on the basis of the horizontal direction component to calculate the movement direction.

The movement direction information is information which has been integrated by an integration unit 410 and then averaged by an averaging unit 430 in a narrow sense, but is not limited thereto. For example, as in the method according to the related art, the peak value of the horizontal direction component may be the movement direction information, or information for which the integration process is performed and the averaging process is not performed may be the movement direction information. In this embodiment, information subjected to a DC component extracting process may be included in the movement direction information.

In this way, it is possible to perform the DC component extracting process for the movement direction information. As shown in FIG. 13A, the estimated movement direction varies due to the influence of, for example, rolling (which becomes remarkable due to the shaking of the hand particularly when the device is held by the hand). The DC component extracting process for the movement direction information makes it possible to suppress a change and thus suppress the variation.

In addition, as shown in FIG. 1, the state detection device may include a change information acquiring unit 500 that acquires change information indicating a change in the movement direction. The movement direction calculating unit 400 adjusts parameters used in the extraction process on the basis of the change information.

In this way, it is possible to adjust the parameters used in the extraction process on the basis of the change information. As described above, since a change is suppressed by the DC component extracting process, there is a concern that a change in the movement direction to be applied to the original result will be suppressed. For example, as shown in FIG. 13A, a motion is changed in the vicinity of a time point 35, but it is slowly changed at about time points 35 to 60 by the DC component extracting process. Therefore, when the movement direction is changed, it is necessary to adjust parameters for reducing the degree of suppression of the change such that the change is accepted. On the contrary, when a change in the movement direction is small, parameters for increasing the degree of suppression of the change are adjusted.

The movement direction calculating unit 400 may include a DC component extracting and filtering unit 450 that performs a filtering process of extracting a DC component. The movement direction calculating unit 400 adjusts the gain of a filter used in the DC component extracting and filtering unit as a parameter used in the extraction process.

As shown in FIG. 14, the DC component extracting and filtering unit 450 may perform the DC component extracting process as follows. The DC component extracting and filtering unit 450 performs a process based on the gain for the difference between an input value at a predetermined time point and an output value at a time point that is one time point earlier than the predetermined time point to calculate an intermediate value and uses the difference between the intermediate value and the input value at the predetermined time point as an output value.

In this way, it is possible to adjust the gain of a DC component extraction filter as a parameter of the extraction process. The gain is, for example, as shown in FIG. 14.

In the movement direction calculating unit 400, the value of the gain may be reduced as a change in the movement direction indicated by the change information increases.

In this way, it is possible to appropriately set the gain on the basis of the change information. In particular, in the filter shown in FIG. 14, the difference (that is, a variation) between the input value and the previous output value is multiplied by the gain. Therefore, when the gain is 1 (under the conditions that the filter operates ideally), the filter completely removes the change. When the change in the movement direction increases, the gain is reduced to decrease the degree of suppression of the change.

The change information acquiring unit 500 may acquire a change in the rotation angle of the apparatus provided with the acceleration sensor 10 as the change information.

In this way, it is possible to acquire the change information on the basis of the rotation angle (or position information). In principle, as described above, the change information needs to be acquired on the basis of the degree of change in the movement direction. However, the movement direction needs to be estimated at the processing time in order to calculate the degree of change in the movement direction at the processing time. As a result, for example, the change in the movement direction is calculated on the basis of the previously estimated movement direction, which causes a time difference. Therefore, in this embodiment, the change information is acquired from the position of the apparatus. The reason is as follows. Since it is premised that the relative position of the apparatus with respect to the body is stable, a change in the position of the apparatus can deal with a change in the movement direction.

As shown in FIG. 1, the state detection device may include a step detecting unit 300 that detects first to N-th (N is an integer equal to or greater than 2) steps as steps in walking or running. The change information acquiring unit 500 may average the change information at an i-th (1≦i≦N) step corresponding to one of the right foot and the left foot and the change information at a j-th (1≦j≦N, i≠j) step corresponding to the other foot of the right foot and the left foot which is different from the foot corresponding to the i-th step and output the averaged change information.

In this way, it is possible to remove a variation in the position information due to the left foot and the right foot. The position information (for example, a yaw angle) varies as shown in FIG. 15 such that the movement direction information varies due to the difference between the left foot and the right foot. Therefore, the averaging process makes it possible to suppress the variation and appropriately adjust a parameter (a filter gain in a narrow sense).

The movement direction calculating unit 400 may average the movement direction information at an m-th (1≦m≦N) step corresponding to one of the right foot and the left foot and the movement direction information at an n-th (1≦n≦N, m≠n) step corresponding to the other foot of the right foot and the left foot which is different from the foot corresponding to the m-th step and extract a DC component from the averaged information to calculate the movement direction.

In this way, the averaging process can also be performed on the movement direction information. The advantages of the averaging process have been described above.

The horizontal direction component extracting unit 100 may extract, as the horizontal direction component, a first coordinate axis component and a second coordinate axis component different from the first coordinate axis component. The movement direction calculating unit 400 extracts a DC component from a first movement direction information item obtained on the basis of the first coordinate axis component and extracts a DC component from a second movement direction information item obtained on the basis of the second coordinate axis component. In addition, the movement direction calculating unit 400 calculates the movement direction on the basis of the first movement direction information item after the extraction process and the second movement direction information after the extraction process.

In this way, even when two components are used as the horizontal direction component, it is possible to perform the DC component extracting process. Specifically, the DC component extracting process may be performed for each of the first coordinate axis component and the second coordinate axis component.

As shown in FIG. 1, the state detection device may include a filtering unit 200 that performs a filtering process of removing a DC component from the horizontal direction component of the detected acceleration. The movement direction calculating unit 400 performs the DC component extracting process on the movement direction information which is obtained on the basis of the filtered horizontal direction component to calculate the movement direction.

In this way, it is possible to calculate the movement direction information on the basis of the filtered horizontal direction component. It is possible to suppress the influence of, for example, an offset and thus expect the appropriate calculation of the movement direction information. In particular, when an integration process is performed, it is possible to prevent the integration of noise, such as an offset. Therefore, this structure is effective.

### 7.4 Embodiments Other than State Detection Device

This embodiment can also be applied to an electronic apparatus including the above-mentioned state detection device.

For example, as shown in FIG. 19, an electronic apparatus including an acceleration sensor 10, an output unit 20, a storage unit 30, a communication unit 40, an operation unit 50, and a state detection device 60 is considered. The structure of the electronic apparatus is not limited to that shown in FIG. 19, but the electronic apparatus may have various structures. For example, some of the components are omitted, or other components are added. In FIG. 19, the state detection device does not include the acceleration sensor 10 and the output unit 20 (the state detection device includes components except for the above-mentioned units in FIG. 1), but the structure is not limited thereto.

The storage unit 30 is a work area of each unit and the function thereof can be implemented by, for example, a memory, such as a RAM, or an HDD (hard disk drive). The communication unit 40 is used for communication with, for example, an external apparatus and may be a wireless communication unit or a wired communication unit. The operation unit 50 is used by the user to operate the electronic apparatus in various ways and may be implemented by, for example, various buttons or a GUI.

The electronic apparatus may be a wristwatch-type device or a device, such as a smart phone. The units shown in FIG. 19 are not necessarily integrally formed. For example, the acceleration sensor 10 may be separately provided. In this case, it is possible to provide a portion including the output unit 20 (a display unit in a narrow sense) at the position where it is easy for the user to view the output unit. In addition, the acceleration sensor 10 can be fixed considering, for example, the convenience of fixation or the accuracy of an acquired signal.

This embodiment can also be applied to a program.

For example, a program may be provided with causes a computer to function as the horizontal direction component extracting unit 100 that calculates the horizontal direction component of the acceleration detected by the acceleration sensor 10, the filtering unit 200 that performs a filtering process of removing a DC component from the horizontal direction component of the detected acceleration, and the movement direction calculating unit 400 that integrates the filtered horizontal direction component to calculate the movement direction.

In addition, a program may be provided which causes a computer to function as the movement direction calculating unit 400 that calculates the movement direction during walking or running on the basis of the acceleration detected by the acceleration sensor 10 and the step detecting unit 300 that detects steps during walking or running. The movement direction calculating unit 400 averages the movement direction information corresponding to the first step and the movement direction information corresponding to the second step different from the first step to calculate the movement direction at the first step.

A program may be provided which causes a computer to function as the horizontal direction component extracting unit 100 that calculates the horizontal direction component of the acceleration detected by the acceleration sensor 10 and the movement direction calculating unit 400 that calculates the movement direction on the basis of the horizontal direction component. The movement direction calculating unit 400 extracts a DC component from the movement direction information which is obtained on the basis of the horizontal direction component to calculate the movement direction.

The program is recorded on an information storage medium. Various kinds of recording media which can be read by the system may be used as the information recording medium. For example, an optical disk, such as a DVD or a CD, a magneto-optical disk, a hard disk (HDD), and a memory, such as a non-volatile memory or a RAM, may be used.

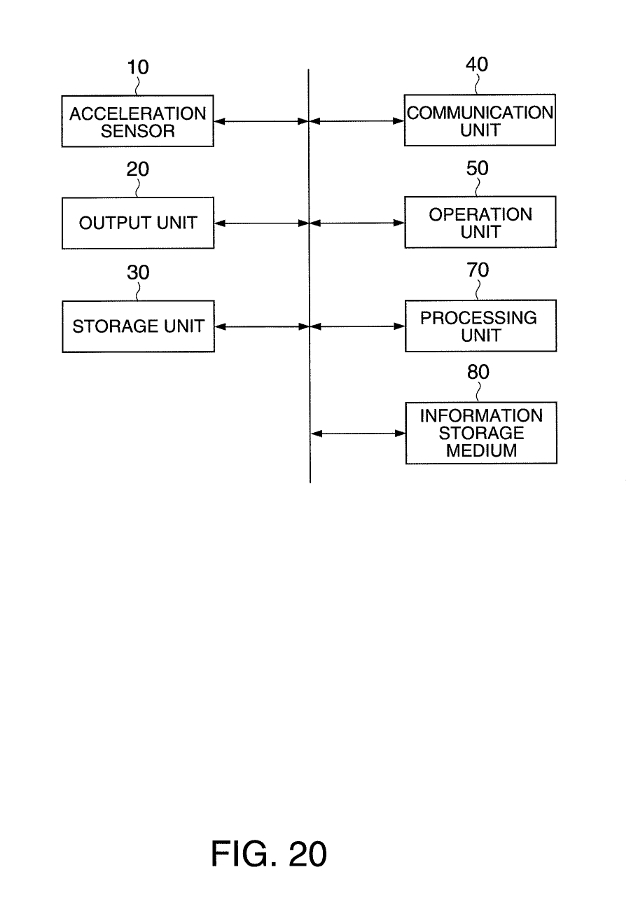

For example, as shown in FIG. 20, in a system including an acceleration sensor 10, an output unit 20, a storage unit 30, a communication unit 40, an operation unit 50, a processing unit 70, and an information storage medium 80, the program is stored in the information storage medium 80. The program stored in the information storage medium 80 is read to the processing unit 70 (for example, a CPU) and the process indicated by the program is performed. For example, a smart phone is considered as the system shown in FIG. 20. The program according to this embodiment is stored in an information storage medium of the smart phone and is executed by, for example, a CPU of the smart phone.

This embodiment has been described in detail above, but it will be understood by those skilled in the art that various modifications and changes of the invention can be made without departing from new matters and effects of the invention. Therefore, all of the modifications are included in the scope of the invention. For example, in the specification or the drawings, a term which is described together with different comprehensive or synonymous terms at least once may be replaced with the different terms at any position in the specification or the drawings. The structure and operation of the state detection device and the electronic apparatus are not limited to those according to this embodiment, but the state detection device and the electronic apparatus may have various other structures and operations.

What is claimed is:

1. A state detection device comprising:
a horizontal direction component extracting unit that obtains a horizontal direction component of acceleration detected by an acceleration sensor; and
a movement direction calculating unit that calculates a movement direction on the basis of the horizontal direction component,
the movement direction calculating unit performing a process of extracting a DC component for movement direction information which is obtained on the basis of the horizontal direction component to calculate the movement direction.

2. The state detection device according to claim 1, further comprising:
a change information acquiring unit that acquires change information corresponding to a change in the movement direction,
wherein the movement direction calculating unit adjusts a parameter which is used in the extraction process on the basis of the change information.

3. The state detection device according to claim 2,
wherein the movement direction calculating unit includes a DC component extracting and filtering unit that performs a filtering process of extracting the DC component, and
the movement direction calculating unit adjusts a gain of a filter used in the DC component extracting and filtering unit as the parameter used in the extraction process.

4. The state detection device according to claim 3,
wherein the DC component extracting and filtering unit performs a process based on the gain for a difference between an input value at a predetermined time point and an output value at a time point that is one time point earlier than the predetermined time point to calculate an intermediate value, and
the DC component extracting process is performed using a difference between the intermediate value and the input value at the predetermined time point as the output value at the predetermined time point.

5. The state detection device according to claim 3,
wherein the movement direction calculating unit reduces the value of the gain as the magnitude of the change in the movement direction indicated by the change information increases.

6. The state detection device according to claim 2,
wherein the change information acquiring unit acquires a change in a rotation angle of an apparatus provided with the acceleration sensor as the change information.

7. The state detection device according to claim 2, further comprising:
a step detecting unit that detects first to N-th (N is an integer equal to or greater than 2) steps as steps in walking or running,
wherein the change information acquiring unit averages the change information at an i-th (1≦i≦N) step corresponding to one of a right foot and a left foot and the change information at a j-th (1≦j≦N, i≠j) step corresponding to the other step of the right foot and the left foot which is different from the i-th step and outputs the averaged change information.

8. The state detection device according to claim 7,
wherein the movement direction calculating unit averages the movement direction information at an m-th (1≦m≦N) step corresponding to one of the right foot and the left foot and the movement direction information at an n-th (1≦n≦N, m≠n) step corresponding to the other step of the right foot and the left foot which is different from the m-th step and performs the process of extracting the DC component for the averaged information to calculate the movement direction.

9. The state detection device according to claim 1,
wherein the horizontal direction component extracting unit extracts, as the horizontal direction component, a first coordinate axis component and a second coordinate axis component different from the first coordinate axis component,
the movement direction calculating unit performs the DC component extracting process for a first movement direction information item which is obtained on the basis of the first coordinate axis component and performs the DC component extracting process for a second movement direction information item which is obtained on the basis of the second coordinate axis component, and
the movement direction calculating unit calculates the movement direction on the basis of the first movement direction information item subjected to the extraction process and the second movement direction information item subjected to the extraction process.

10. The state detection device according to claim 1, further comprising:
a filtering unit that performs a filtering process of removing a DC component for the horizontal direction component of the detected acceleration,
wherein the movement direction calculating unit performs the DC component extracting process for the movement direction information which is obtained on the basis of the horizontal direction component subjected to the filtering process of removing the DC component to calculate the movement direction.

11. An electronic apparatus comprising the state detection device according to claim 1.

12. An electronic apparatus comprising the state detection device according to claim 2.

13. An electronic apparatus comprising the state detection device according to claim 3.

14. An electronic apparatus comprising the state detection device according to claim 4.

15. An electronic apparatus comprising the state detection device according to claim 5.

16. An electronic apparatus comprising the state detection device according to claim 6.

17. An electronic apparatus comprising the state detection device according to claim 7.

18. An electronic apparatus comprising the state detection device according to claim 8.

19. An electronic apparatus comprising the state detection device according to claim 9.

20. A program that causes a computer to function as:
a horizontal direction component extracting unit that obtains a horizontal direction component of acceleration detected by an acceleration sensor; and
a movement direction calculating unit that calculates a movement direction on the basis of the horizontal direction component,
the movement direction calculating unit performing a process of extracting a DC component for movement direction information which is obtained on the basis of the horizontal direction component to calculate the movement direction.
